(19) United States
(12) Patent Application Publication
(10) Pub. No.: US 2008/0015010 A1
(43) Pub. Date: Jan. 17, 2008

(54) CAMERA-EQUIPPED NETWORKED GAMING MACHINE SYSTEM AND METHOD FOR TWO-WAY COMMUNICATION

(76) Inventor: John M. Bird, Sparks, NV (US)

Correspondence Address: Zilka-Kotab, PC, P.O. BOX 721120, SAN JOSE, CA, 95172-1120, US

(21) Appl. No.: 11/780,199

(22) Filed: Jul. 19, 2007

Related U.S. Application Data
(63) Continuation of application No. 11/373,851, filed on Mar. 10, 2006.
Application No. 11/373,851 is a continuation-in-part of application No. 11/342,333, filed on Jan. 26, 2006.
(63) Continuation-in-part of application No. 11/356,714, filed on Feb. 16, 2006.
(60) Provisional application No. 60/648,929, filed on Jan. 31, 2005.
(60) Provisional application No. 60/660,870, filed on Mar. 10, 2005.
(60) Provisional application No. 60/660,869, filed on Mar. 10, 2005.
(60) Provisional application No. 60/660,871, filed on Mar. 10, 2005.
(60) Provisional application No. 60/660,872, filed on Mar. 10, 2005.
(60) Provisional application No. 60/660,868, filed on Mar. 10, 2005.
(60) Provisional application No. 60/660,896, filed on Mar. 10, 2005.
(60) Provisional application No. 60/654,647, filed on Feb. 18, 2005.

(51) Int. Cl. G07F 17/32

(52) U.S. Cl. 463/20; 463/35; 463/42

(57) ABSTRACT

A gaming machine system and associated method are provided involving a plurality of networked gaming machines. Each of the networked gaming machines is equipped with a display and/or a speaker for providing output, and a camera and/or a microphone for receiving input. In use, the communication devices are capable of being used by users of the gaming machines for two-way communication with at least one other party.

### RELATED APPLICATION(S)

The present application is a Continuation of non-provisional application Ser. No. 11/373,851 filed Mar. 10, 2006; which is a Continuation-In-Part of U.S. non-provisional application Ser. No. 11/342,333 filed Jan. 26, 2006, which claims priority from a provisional application filed Jan. 31, 2005 under Ser. No. 60/648,929 and provisional application Ser. Nos. 60/660/870, 60/660,869, 60/660,871, 60/660,872, 60/660,868, and 60/660,896, all of which were filed on Mar. 10, 2005; and which is also a Continuation-In-Part of U.S. non-provisional application Ser. No. 11/356,714 filed Feb. 16, 2006, which claims priority from a provisional application filed Feb. 18, 2005 under Ser. No. 60/654,647, which are each incorporated herein by reference in their entirety for all purposes.

### BACKGROUND AND FIELD OF THE INVENTION

The present invention relates to gaming, and more particularly to gaming machines.

### SUMMARY

A gaming machine system and associated method are provided involving a plurality of networked gaming machines. Each of the networked gaming machines is equipped with a display and/or a speaker for providing output, and a camera and/or a microphone for receiving input. In use, the communication devices are capable of being used by users of the gaming machines for two-way communication with at least one other party.

### BRIEF DESCRIPTION OF THE DRAWINGS

FIG. 1 is a block diagram of a data collection unit (DCU) and fully digital network-enabled system interface board (SIB) in a casino network communication system employing a single twisted pair cabling (category 5 or the like) constructed in accordance with one embodiment.

FIG. 2 is a block diagram of a DCU and analog network-enabled SIB in a casino network communication system employing a single twisted pair cabling (category 5 or the like) constructed in accordance with another embodiment.

FIG. 3 is an example of a frequency response for category 5 twisted pair cabling along with a frequency allocation partition for the DCU and network-enabled SIBs depicted in FIGS. 1 and 2, in accordance with one embodiment.

FIG. 4 illustrates a back-end server connected to multiple DCUs, where the DCUs have multiple network lines connected to non-adjacent network-enabled SIB clusters.

FIG. 5 illustrates shared characteristics of a DCU and network-enabled SIB interface, in accordance with one embodiment.

FIG. 6 further illustrates a virtual link, in accordance with one embodiment.

FIG. 7 illustrates a gaming machine that may be utilized for providing user communication, in accordance with one embodiment.

FIG. 8 shows a method for allowing communication between a gaming machine user and at least one other party, in accordance with one embodiment.

FIG. 9 illustrates a gaming machine that may be utilized for providing user communication, in accordance with one embodiment.

FIG. 10 shows a method for allowing communication between a gaming machine user and at least one other party, in accordance with one embodiment.

FIG. 11 illustrates a gaming machine network configured in a tapped configuration, in accordance with one embodiment.

FIG. 12 illustrates a gaming machine network configured in a daisy-chain configuration, in accordance with another embodiment.

FIG. 13 illustrates a gaming machine, in accordance with one embodiment.

FIG. 14 illustrates a gaming machine that may be utilized, in accordance with one embodiment.

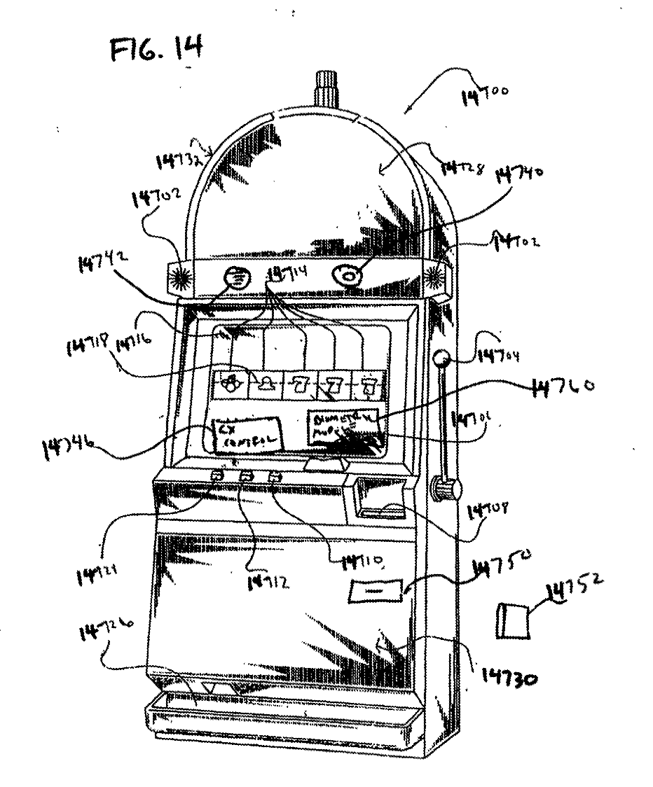

FIG. 15 shows a method for reconciling received biometric information, and smart device information and/or personal identifier information, in accordance with one embodiment.

FIG. 16 illustrates a gaming machine, in accordance with one embodiment.

FIG. 17 is a cross-section of line 8-8 shown in FIG. 16, showing an exemplary gaming machine candle, in accordance with one embodiment.

FIG. 18 illustrates a centralized game board architecture, in accordance with one embodiment.

FIG. 19 illustrates one exemplary game board, in accordance with another embodiment.

FIG. 20 illustrates a gaming machine, in accordance with one embodiment.

FIG. 21 illustrates a gaming machine, in accordance with one embodiment.

FIG. 22 is a cross-sectional view taken along line 3-3 of FIG. 21, showing the player buttons and associated lights, in accordance with one embodiment.

FIG. 23 is a graph showing the continuous variation in light intensity over time with respect to a light of each player button, in accordance with another embodiment.

FIG. 24 is a graph showing the continuous variation of light color over time with respect to a light of each player button, in accordance with yet another embodiment.

### DETAILED DESCRIPTION

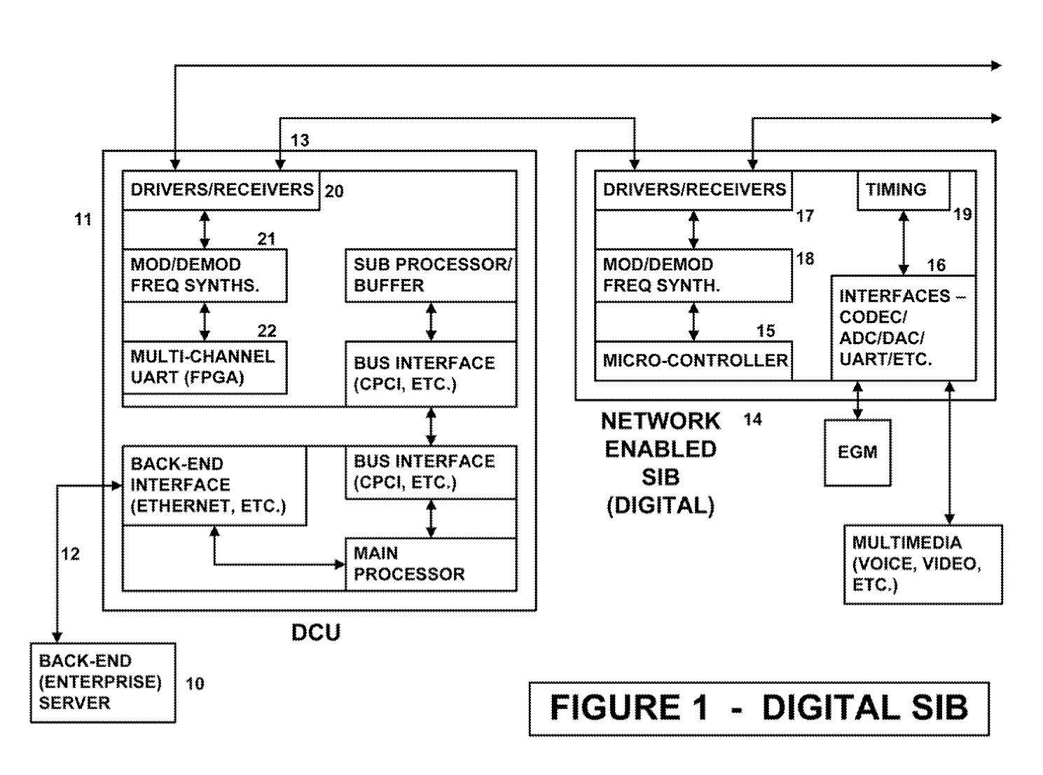

An exemplary high-speed transport medium will be described in the context of FIGS. 1-6, as one illustrative (but not limiting) example of a network. It should be noted, of course, that any desired network may be employed which is capable of any desired functionality.

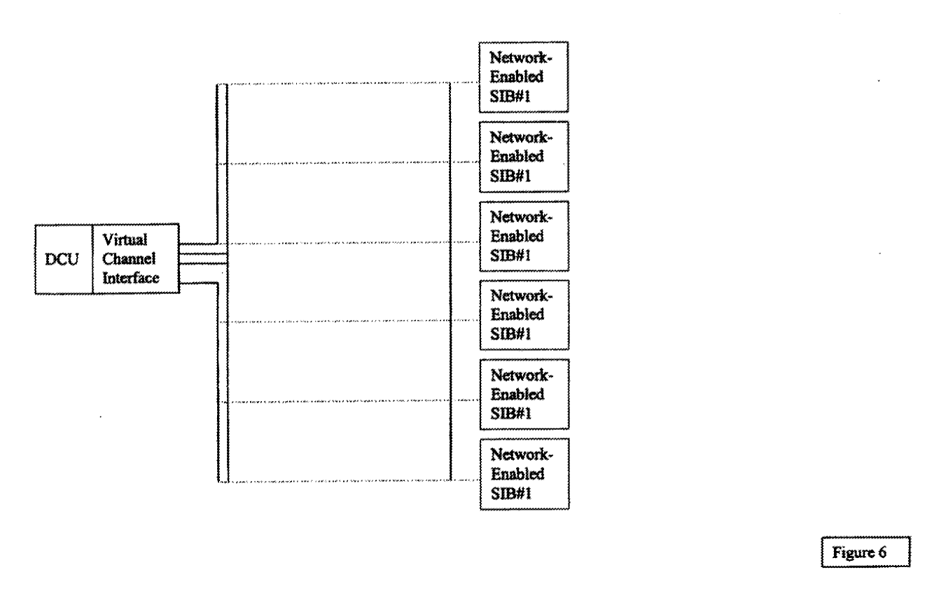

Still yet, in the figures subsequent FIG. 6, additional details will be described regarding an exemplary gaming machine, the features of which may or may not be used in the context of any other embodiment. Further, additional illustrative functional information will be set forth.

Optional High-Speed Network Environment

With reference to FIG. 1 of the illustrated embodiment, a casino environment back-end computer (BEC) 10 is connected to a data collection unit (DCU) 11 via an external high-speed communication link 12 (e.g., Gigabit Ethernet, SONET, etc.). Further, the DCU 11 is, in turn, connected to at least one system interface board (SIB) 14 via a similar, or same, high-speed transport medium 13.

It is to be understood that the transport medium 13 for any of the aforementioned connections [e.g. BEC/DCU, DCU/SIB, etc.] can be any of a number of different types (e.g., T-1 line, coaxial cable, fiber optic cable, wireless, and so on) and can support protocols and services such as Ethernet, Internet Protocol, asynchronous transfer mode (ATM), among any others desired.

In the context of the present description, the DCU 11 may include a server, personal computer, workstation, and/or any other type of computing device. Further, the DCU 11 may be provided with one or more external transport medium connectors (e.g. a category 5 twisted pair, power line interface, fiber optic link, coaxial cable, wireless, among any others desired). In accordance with one of many embodiments disclosed herein, a number of network-enabled devices may share one (or more) of the transport medium connectors. Network-enabling electronics may further be either built into or attached to the SIB 14. This connection may provide access to the network via the DCU 11.

The DCU 11 and the network-enabled SIBs 14 operate in accordance with one embodiment to allow multiple multimedia devices (e.g. cameras, microphones, etc.), electronic gaming machines (EGMs), entertainment devices, personal digital assistants (PDAs), and/or any other network-enabled devices, etc., to, once initialized, communicate independently with respect to each other over the transport medium 13. Of course, each SIB 14 may or may not be built into the associated network-enabled device. In use, the DCU 11 and the network-enabling SIBs 14 of the present embodiment may be advantageous because they are simple, reliable, scalable, and inexpensive.

The DCU 11 may be configured to be a stand-alone unit, but may also be interfaced to the BEC 10 and/or other computer(s). The DCU 11 may also perform various functions, such as the following: (1) establishing communication with connected network-enabled devices via the SIBs 14; (2) assigning each newly connected network-enabled device a unique address (including a channel); and/or (3) processing and arbitrating data traffic. The DCU 11 may further be in continuous communication with the network-enabled devices via the SIBs 14.

Similarly, the network-enabled devices are in continuous communication with the DCU 11 via the SIBs 14. Signaling between the DCU 11 and the network-enabled devices may occur in frequency bands conforming to a frequency response of the transport medium 13. The transport medium frequency spectrum may further be allocated to different information data types (e.g. voice, video, data, etc.).

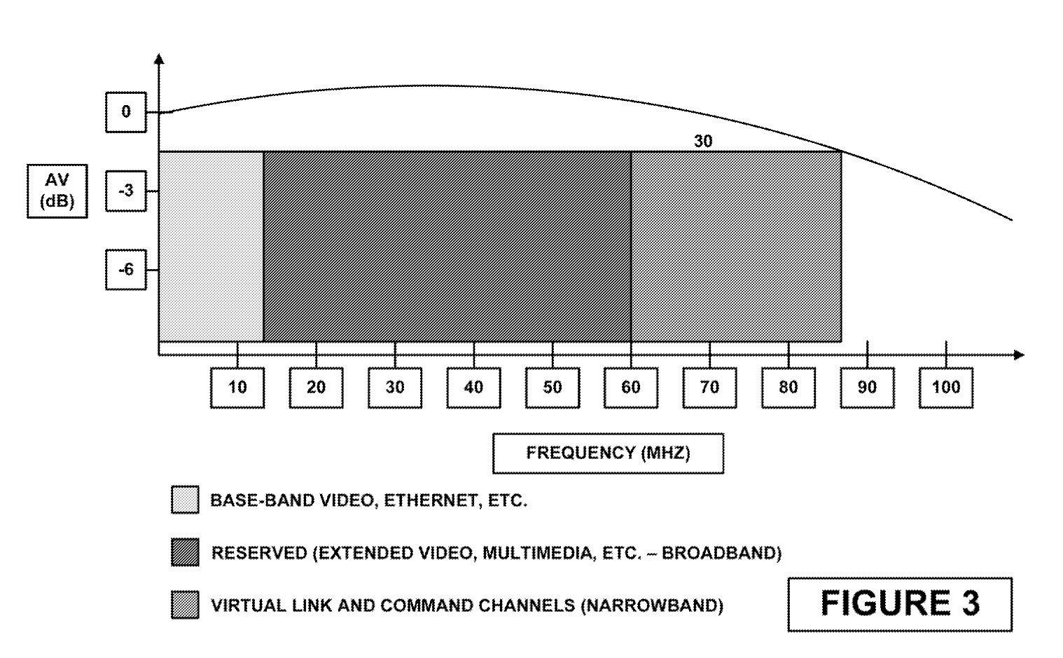

For example, FIG. 3 shows a frequency spectra example of the aforementioned, exemplary communication platforms. The DCU 11 may transmit messages to the network-enabled devices via the SIBs 14 on individual frequency channels, as indicated at item 30, shown in FIG. 3. The DCU 11 assigns an operational, or frequency, channel on the transport medium 13 to each network-enabled device as indicated at item 30. The DCU 11 and the network-enabled devices may be further configured to coexist with other media, such as base-band video, etc.

Network-enabling electronics may include small, inexpensive modules which may be built into each SIB 14, and/or any network-enabled device (camera, etc.) to provide an interface with the transport medium 13. Such network interface may use common and inexpensive connectors (e.g. RJ-45 phone style jack for category 5 cabling, a fiber optic connector for optical networking, an antenna for wireless, etc.), or any other desired connectors, for that matter.

Each fully digital SIB 14 may be configured with a microcontroller 15, converters 16 [i.e. coder/decoder (CODEC)/analog-to-digital converter (ADC)/digital-to-analog converter (DAC)/universal asynchronous receiver/transceiver (UART), etc. for multimedia], a driver/receiver unit 17, a frequency synthesizer and modulator/demodulator unit 18 and/or associated support circuitry for timing 19, power control, and so on.

In use, the network-enabled SIB 14 may perform the following optional functions (among others, if desired): (1) monitoring network-enabled device (e.g. EGM, etc.) activity (e.g. polling EGMs, accepting EGM output, etc.); (2) performing requests from the DCU 11 (e.g. getting EGM meter readings, etc.); and/or (3) performing digital-to-analog and/or analog-to-digital conversions (DAC/ADC) as required for digital data/voice transmission, if configured as in FIG. 1.

Data may modulate a carrier, which is transmitted to the DCU 11. In a similar fashion, the DCU 11 may modulate a corresponding carrier with data that is sent to one of the SIBs 14. In one embodiment, the carrier may be used as the local oscillator in the driver/receiver unit 17.

Network-enabled device (e.g., EGM, etc.) data transmissions to and from the associated network-enabled SIB 14 may be asynchronous using a UART. An associated data rate may be limited only by the baud rate of such network-enabled device. The network-enabled SIB 14, in turn, may be connected directly to the transport medium 13 via a transport medium connector. Likewise, the DCU 11 in FIG. 1 may be connected directly to the transport medium 13 via a transport medium connector.

As shown in FIG. 1, the DCU 11 may include a driver/receiver unit 20, a multiple-frequency generator unit 21 having a modulator/demodulator for each of the network-enabled devices and associated SIBs 14, and a multi-channel UART 22, which may be provided using a field programmable gate array (FPGA).

As stated previously, the DCU 11 and network-enabled SIBS 14 communicate over frequency channels within the frequency response range of the transport medium 13 (e.g., 0-100 Mhz for category 5 cabling). These frequency channels may be useful for the embodiment in FIG. 1. Modulation techniques such as frequency shift keying (FSK), quadrature amplitude modulation (QAM), pulse amplitude modulation (PAM), etc. may be used to maximize a bits/Hertz ratio, thereby maximizing the number of network-enabled devices and associated SIBs 14 that can be supported on a single link.

FIG. 1 thus depicts components in the DCU 11, and network-enabled devices interfaced via associated SIBs 14. As shown, the configuration in FIG. 1 provides for bi-directional communication between the DCU 11 and each network-enabled device via the corresponding SIB 14, in a digital format.

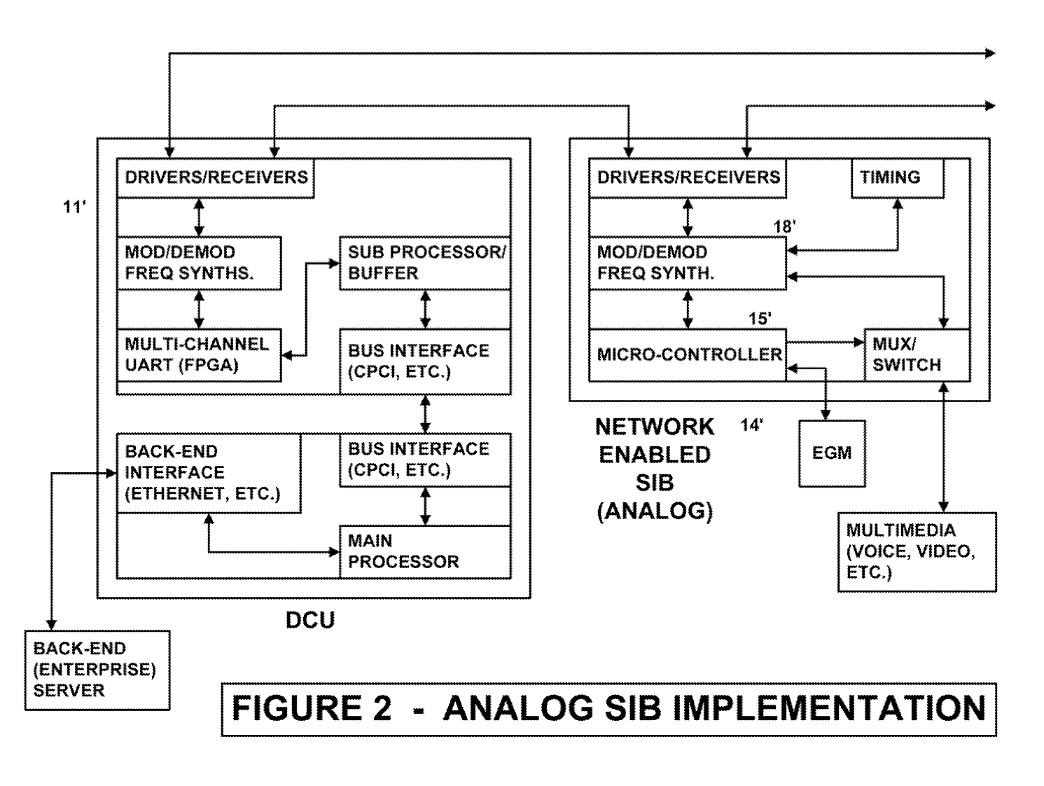

FIG. 2, on the other hand, depicts another embodiment of the DCU 11 and SIB 14 which allows bi-directional communication in an analog format. With reference to FIG. 2, the network-enabled device and associated SIB 14′ are configured for analog transmissions (e.g. frequency modulation), as opposed to digital transmissions generated by the network-enabling device depicted in FIG. 1. FIG. 2 depicts the network-enabled SIB 14′ to include a micro-controller 15′, and a frequency synthesizer modulator/demodulator 18′ that uses analog data (e.g. voice, video, etc.) to modulate a carrier. The modulated carrier may be demodulated and converted as necessary into digital data at and by the DCU 11′.

A combination of digital and analog transmissions may be implemented in network-enabling electronics as needed to enhance performance and/or decrease cost. Such resultant system would, in such embodiment, result in a merger of some component blocks mentioned herein above.

As stated previously the DCU 11 may be provided with a plurality of data/communication media. For example, casino devices such as slot machines, EGMs, security cameras, hand-held PDA-type devices, etc., and any other controllable and/or information device may be connected to the transport medium 13 within a casino, allowing information exchange between such devices.

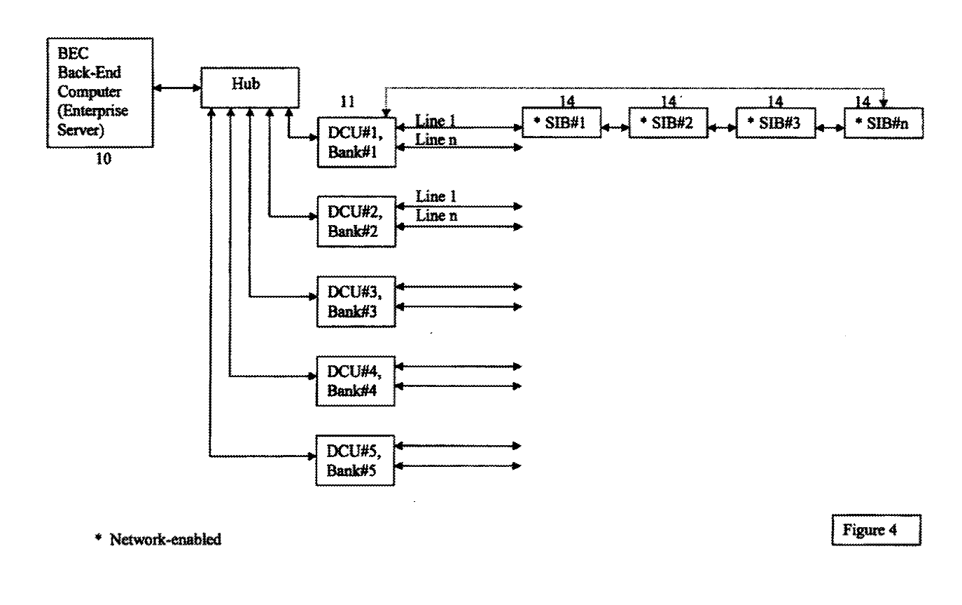

FIG. 4 illustrates a back-end server 10 connected to multiple DCUs 11, where the DCUs 11 have multiple network lines connected to non-adjacent network-enabled SIB 14 clusters. With continuing reference to FIG. 4, the BEC 10 is shown configured to interface with one or more DCU(s) 11. The DCU(s) may manage both narrowband and/or broadband communications with various network-enabled devices via SIBs 14 connected to the transport medium 13.

An application example of a broadband requirement would involve having the BEC 10 provided with a broadband communication link (e.g. a coaxial cable, DSL, and/or fiber optic cable) to receive information destined for a network-enabled device on a casino floor via satellite. The BEC 10 may be configured to communicate with different DCUs 11 through different transmission media [such as a hybrid fiber optic coaxial cable, radio frequency (RF) link, among others], and may use different signal protocols.

With continued reference to FIG. 4, each DCU 11 may support multiple transport medium lines for (non-adjacent) SIB 14 clusters. In this way, multiple DCUs 11 do not have to be used, unless such a situation is desired.

Thus, data may be multiplexed onto a single set of wires or similar medium, and may be potentially available for all devices connected to the medium.

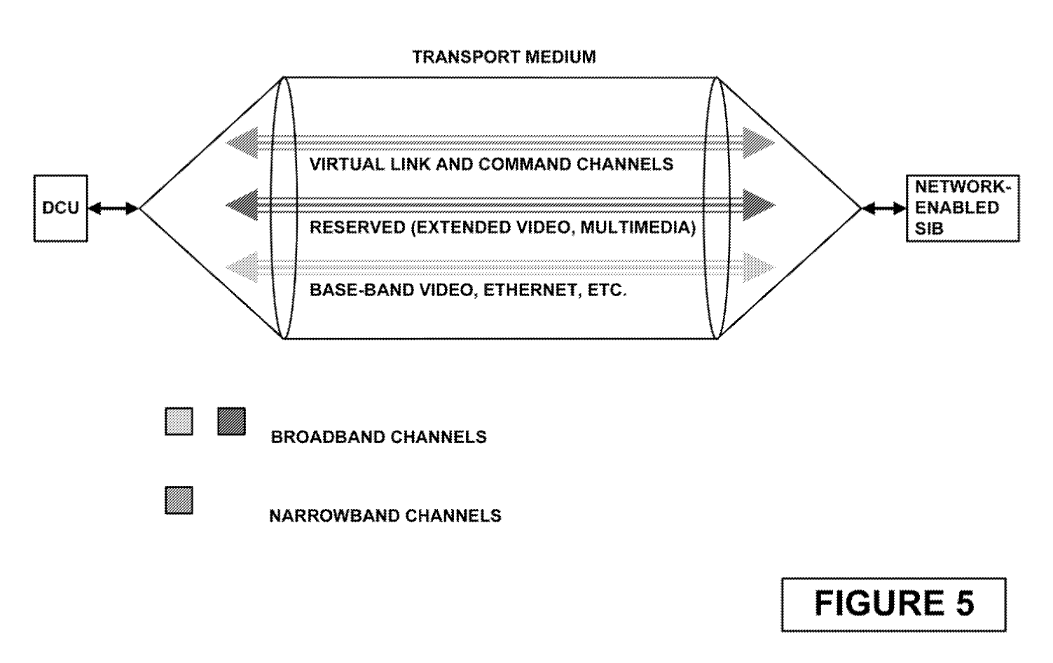

Using logic in or near the network-enabled devices and/or associated SIB 14, each device may decide whether it is the appropriate destination for incoming information. In a distributed embodiment, the transmission medium 13 may be partitioned into a set of virtual links and, optionally, virtual contained channels. The virtual links may carry data, and may be narrowband and/or broadband, while the virtual command channels may carry switching protocols and be narrowband, as indicated in FIG. 5. FIG. 6 further illustrates a virtual link, in accordance with one embodiment.

For device-device or BEC-device communication, a switching protocol may mark each connect request with various information such as the: (1) initiating device; (2) recipient identifier requirements; (3) progress information (e.g. request answered); and/or (5) any synchronization and/or arbitration information.

An exemplary data routing sequence using the distributed processing method of the present embodiment will now be set forth. First, the BEC 10 receives a request to play a table game from a legitimate Internet gambler. The request is routed to the DCU 11, and a copy of the relevant information about the connection attaches a player identifier.

Each network-enabled device and associated SIB 14 connected to the transport medium 13 then examines the packet (being broadcast over a virtual command channel) using the enclosed connect information, to determine if it is an appropriate destination. If so, the device constructs a synchronization packet from the incoming player identifier and a unique device identifier, and transmits such synchronization packet on the virtual data channel. The DCU 11 receives the transmitted device identifier and sends a device connect packet back to the BEC 10. This device connect packet may include the virtual link address where the connection may be made. When the device and associated SIB 14 is ready to connect, the device/SIB 14 acknowledges by re-transmitting a synchronization packet. The device/SIB 14 then may connect to the virtual link.

In subsequent figures, additional details will be described regarding an exemplary gaming machine, the features of which may or may not be used in the context of the present embodiment. Further, additional illustrative functional information will be set forth. It is again strongly noted that the following information is set forth for illustrative purposes and should not be construed as limiting in any manner.

Additional Exemplary Options

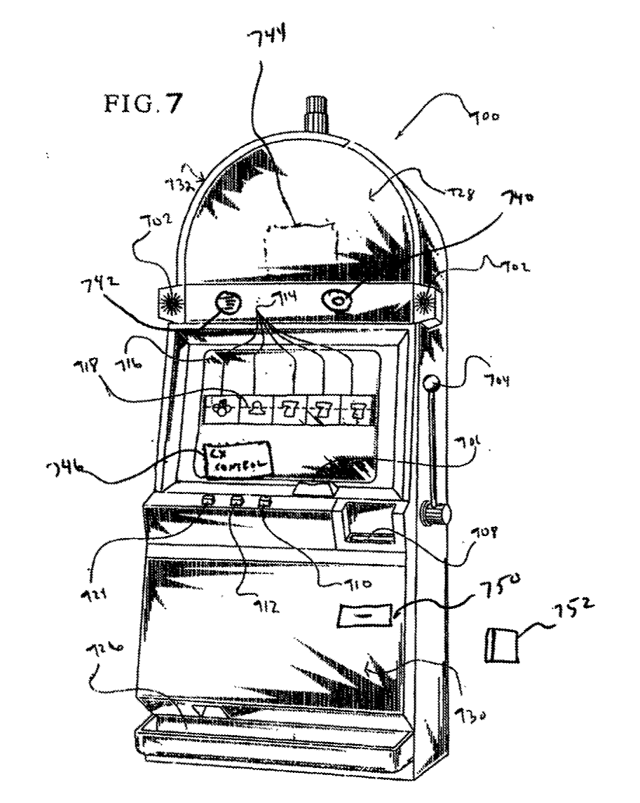

FIG. 7 illustrates a gaming machine 700 that may be utilized for providing user communication, in accordance with one embodiment. While not shown, the gaming machine 700 may be coupled to other similar gaming machines 700 via a network (not shown), for reasons that will soon become apparent.

In one embodiment, such network may, optionally, take the form of the transport medium 13 of FIG. 1 or 2, wherein the gaming machine 700 includes an electronic gaming machine (EGM) that interfaces such transport medium 13. Of course, however, the gaming machines 700 may be interconnected via any desired network capable of allowing user communication.

As shown, the gaming machine 700 includes a conventional reel-type slot gaming machine 700. The gaming machine 700 includes an exterior housing 732 and a front face including a primary gaming machine main display 716, and a belly glass 730.

While the gaming machine 700 is shown to include a conventional reel-type slot gaming machine 700, it should be noted that the gaming machine 700 may take the form of absolutely any game of chance. Thus, the present reel-type slot gaming machine embodiment is set forth or illustrative purposes only and should not be construed as limiting in any manner. To this end, any (or none) of the following features of the reel-type slot gaming machine embodiment may be incorporated into the gaming machine, and still fall within the scope of the claims.

As shown, the primary gaming machine main display 716 includes windows 714 each of which displays a single reel assembly of the slot gaming machine 700. Horizontal pay lines 718 span the windows and allow for a single winning combination. The main display 716 may, in one embodiment, include a cathode ray tube (CRT), liquid crystal display (LCD), organic light emitting diode (OLED) display, etc., with a touch screen layer positioned over the display which may be used to allow user input in lieu of and/or in addition to mechanical manual control.

Player buttons 710, 712, and 724 are further provided between the belly glass 730 and main display 716 and allow the player to control operation of the gaming machine 700 in combination with/instead of the associated touch screen. In addition, a lever 704 may be included on one side of the exterior housing 732 to allow a player alternative control of the gaming machine 700. A coin acceptor 706 and a bill acceptor 708 are provided near the play buttons as shown. Further, a coin tray 726 is provided near the bottom of slot gaming machine 700 to collect coin pay outs from winning plays.

Strictly, as an option, a secondary gaming machine 728 may be positioned on a top portion of the gaming machine 700. Such secondary gaming machine 728 may include any of the desired features set forth earlier during the description of the main display 716.

For reasons that will soon become apparent, the gaming machine 700 may be equipped with a microphone 742 and one or more cameras 740 positioned at a height on the gaming machine 700, such that at least a face of a user is directed thereinto, during use of the gaming machine 700. Still yet, speakers 702 are provided.

In use, the microphone 742, camera 740, speakers 702, and main display 716 may be used by a user of the gaming machine 700 to communicate with at least one other party. Such other party may include, but is not limited to another user (s), a concierge, a bartender, a cocktail waitress, and/or any other party with whom two-way communication is desired.

While not shown, an alphanumeric keypad may also be provided for facilitating communication. Of course, such alphanumeric keypad may include a mechanical alphanumeric keypad, and/or a virtual alphanumeric keypad displayed via the main display 716.

Optionally, a separate display 744 may be positioned on the gaming machine 700 for dedicated use during such two-way communication. Of course, both the main display 746 and the separate display 744 may be used in combination (i.e. for two-way communication with multiple parties, etc.), as appropriate. This may be particularly beneficial when the gaming machine 700 is not in play.

As an additional option, video conferencing, real-time or near real-time game-related or non-game related gaming machine user interaction, as well as various other features beyond (and/or in addition to) mere security monitoring functions may be carried out utilizing the gaming machine 700. Of course, non-real-time two-way communication may further be provided.

In order to control the aforementioned two-way communication, a communication control interface 746 may be utilized. As an option, such communication control interface 746 may simply be displayed on the main display 716 (or the separate display 744, if desired). In use, the communication control interface 746 may be used for allowing a user to initiate the two-way communication, control with whom the two-way communication is initiated, as well as terminate two-way communication. For example, a plurality of buttons may be depicted on the communication control interface 746, each corresponding to a concierge, a bartender, another user, a cocktail waitress, etc. for initiating communication therewith.

As an option, the two-way communication may or may not be carried out during play, of a game on the gaming machine 700. For example, the game being played on the gaming machine 700 may be continued during the two-way communication. In one embodiment, this may be accomplished by ensuring that the separate display 716 or only a portion of the main display 716 is utilized for the two-way communication. Of course, only audible two-way communication may be allowed, as an option. To this end, service may be requested during play and/or two-way communication among gaming machine users may be allowed to enhance a multiple-user experience (e.g. allowing users to monitor each other's score, play, etc. and comment thereon in real-time, etc.). Still yet, in the alternative, the game may be paused, or at least a portion (e.g. audible portions, visual portions, etc.) be suppressed to accommodate the two-way communication.

In one optional embodiment, to facilitate two-way communication with other gaming machine users, the gaming machine 700 may be equipped with a gaming card reader/processor 750. In such embodiment, a plurality of the gaming machine users are each provided with gaming cards 752. Such gaming cards 752 may include a player identifier and an account tracking identifier for tracking a monetary account associated with the player.

It should be noted that, in the context of the present description, any substitute mechanism [i.e. biometric identifier and associated database, jewelry-mounted radio-frequency identifier (RFID), personal identifier number (PIN), etc.] may be used as a substitute for the gaming card 752 and associated gaming card reader/processor 750.

As an option, for reasons that will soon become apparent, the gaming card 750 may include a plurality of additional player identifiers associated with the player identifier. One sample data structure that may be situated on each gaming card 750 is set forth in Table 1.

TABLE 1

| | | Associated Player |
|---|---|---|
| Player Identifier | Account Information | Identifiers |
| Player ID1 | Player Balance | Player ID2 |
| | Player Credit | Player ID3 |
| | Player Local Residence | Player ID4 |

This data structure may be established upon obtaining the card when the user first enters and/or re-enters a casino. For example, the user may arrive with a group (e.g. family, a party of friends, part of an organization attending a seminar, etc.), and may manually associate the other players of the group with his/her player identifier, as set forth in Table 1. Of course, this may be done automatically based on reservations, predetermined lists, etc. As a further option, a player may have multiple groups associated therewith. In such case, the user may have multiple lists of player identifiers each associated with a different group.

To this end, in the present embodiment, a user may insert the associated gaming card 752 into the gaming card reader/processor 750 of the corresponding gaming machine 700, during play, for allowing the user to communicate with players associated therewith by way of any one or more of the communication devices associated with the gaming machine 700.

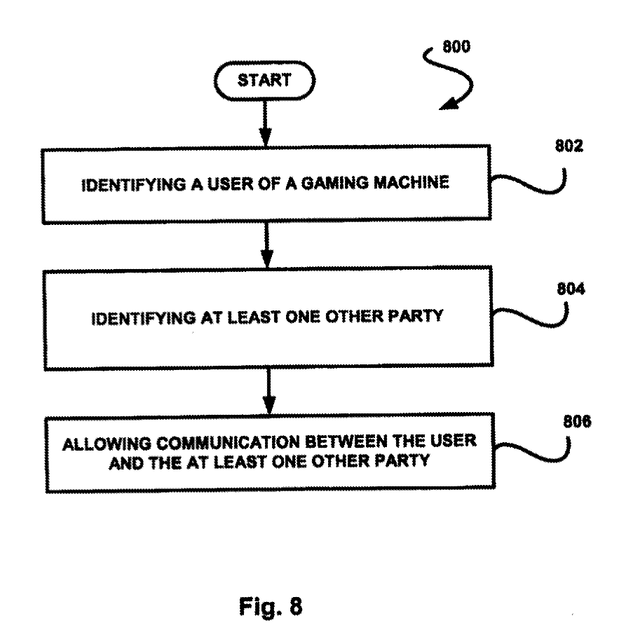

More information associated with one exemplary embodiment of such specific two-way communication will be set forth in FIG. 8.

FIG. 8 shows a method 800 for allowing communication between a gaming machine user and at least one other party, in accordance with one embodiment. As an option, the method 800 may be implemented in the context of the architecture and environment of the previous figures. Of course, however, the method 800 may be carried out in any desired environment.

Initially, in operation 802, at least one first user of a gaming machine is identified. As an option, this may be accomplished by reading a data structure (e.g. Table 1 hereinabove, etc.) from a gaming card associated with the first user positioned and playing at a first gaming machine. As a further option, such operation 802 may include identifying a player identifier associated with the first user. Of course, any other available identifying technique may be used to accomplish this operation.

Next, in operation 804, at least one other party is identified. Such other party may include, but is not limited to another gaming machine user (who may be identified similar to operation 802), a concierge, a bartender, a cocktail waitress, and/or any other party who desires to communicate with the at least one user.

To this end, communication may be provided between the at least one user and the at least one other party. See operation 806. Thus, communication is facilitated between a plurality of gaming machine users. Further, paging may be performed in a more personal manner by avoiding use of a public address system by paging a user directly at an associated gaming machine.

Of course, the communication of operation 806 may be initiated and controlled in any desired manner. For example, prior to operation 806, it may be determined whether the at least one user is authorized to communicate with the at least one other party. Further, such determination may be provided in any desired manner [i.e. reading a data structure (e.g. Table 1 hereinabove, etc.)]. Thus, the communication may be provided based on the foregoing determination.

Further, communication may even be provided between more than two parties simultaneously. For instance, split-screens, etc. may be used to allow multiple users to simultaneously communicate from remote locations in the casino environment.

Still yet, a “presence” of all other users associated therewith may be displayed by the gaming machine during play. To this end, each of the users may select with whom communication is desired, from a set of available users.

Even still, in combination with and/or instead of operation 806 (in the context of an example where the at least one other party is a second gaming machine user), the first gaming machine may be located for the second gaming machine user. Of course, the present embodiment may have numerous applications.

Just by way of example, a map of all gaming machines (and an associated area of the casino or gaming environment) may be stored. Upon locating the gaming machine being used by the first user, a map may be presented (to the second user at the second gaming machine, for example), in order to thereby locate the first user. Since the location of the second user is also known, walking directions may also be provided. Thus, users may thus more easily locate each other (as well as communicate with each other), during use of the present embodiment.

More illustrative information will now be set forth regarding various optional architectures and features with which the foregoing technique may or may not be implemented with the present embodiment, per the desires of the user. It should be strongly noted that the following information is set forth for illustrative purposes and should not be construed as limiting in any manner. Any of the following features (and previous, for that matter) may be optionally incorporated with or without the exclusion of other features described during the description of the present embodiment.

Additional Exemplary Options

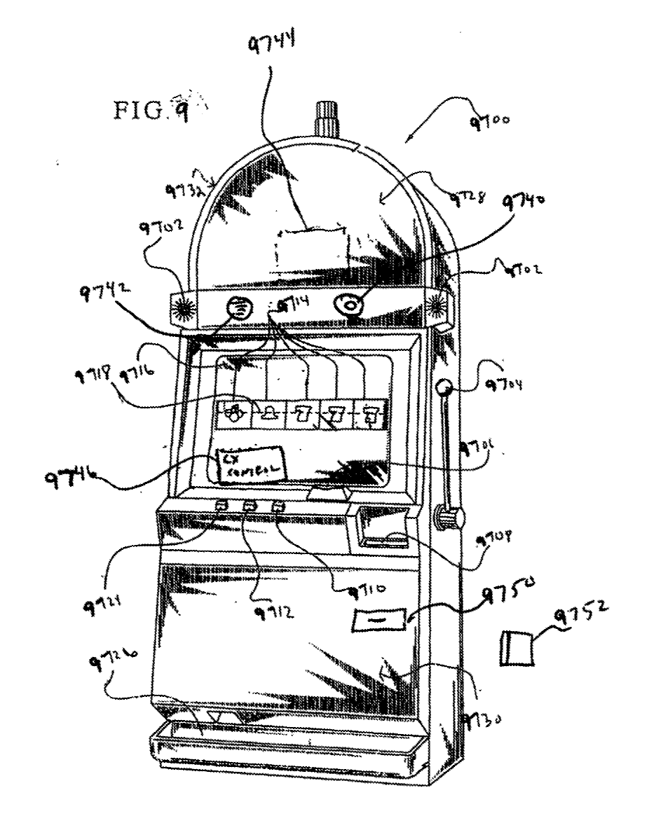

FIG. 9 illustrates a gaming machine 9700 that may be utilized for providing user communication, in accordance with one embodiment. While not shown, the gaming machine 9700 may be coupled to other similar gaming machines 9700 via a network (not shown), for reasons that will soon become apparent.

In one embodiment, such network may, optionally, take the form of the transport medium 13 of FIG. 1 or 2, wherein the gaming machine 9700 includes an electronic gaming machine (EGM) that interfaces such transport medium 13. Of course, however, the gaming machines 9700 may be interconnected via any desired network capable of allowing user communication.

As shown, the gaming machine 9700 includes a conventional reel-type slot gaming machine 9700. The growing machine 9700 includes an exterior housing 9732 and a front face including a primary gaming machine main display 9716, and a belly glass 9730.

While the gaming machine 9700 is shown to include a conventional reel-type slot gaming machine 9700, it should be noted that the gaming machine 9700 may take the form of absolutely any game of chance. Thus, the present reel-type slot gaming machine embodiments is set forth for illustrative purposes only and should not be construed as limiting in any manner. To this end, any (or none) of the following features of the reel-type slot gaming machine embodiment may be incorporated into the gaming machine, and still fall within the scope of the claims.

As shown, the primary gaming machine main display 9716 includes windows 9714 each of which displays a single reel assembly of the slot gaming machine 9700. Horizontal pay lines 9718 span the windows and allow for a single winning combination. The main display 9716 may, in one embodiment, include a cathode ray tube (CRT), liquid crystal display (LCD), organic light emitting diode (OLED) display, etc., with a touch screen layer positioned over the display which may be used to allow input in lieu of and/or in addition to mechanical manual control.

Player buttons 9710, 9712, and 9724 are further provided between the belly glass 9730 and main display 9716 and allow the player to control operation of the gaming machine 9700 in combination with/instead of the associated touch screen. In addition, a lever 9704 may be included on one side of the exterior housing 9732 to allow a player alternative control of the gaming machine 9700. A coin acceptor 9706 and a bill acceptor 9708 are provided near the play buttons as shown. Further, a coin tray 9726 is provided near the bottom of slot gaming machine 9700 to collect coin pay outs from winning plays.

Strictly as an option, a secondary gaming machine 9728 may be positioned on a top portion of the gaming machine 9700. Such secondary gaming machine 9728 may include any of the desired features set forth earlier during the description of the main display 9716.

For reasons that will soon become apparent, the gaming machine 9700 may be equipped with a microphone 9742 and one or more cameras 9740 positioned at a height on the gaming machine 9700, such that at least a face of a user is directed thereinto, during use of the gaming machine 9700. Still yet, speakers 9702 are provided.

In use, the microphone 9742, camera 9740, speakers 9702, and main display 9716 may be used by a user of the gaming machine 9700 to communicate with at least one other party. As mentioned previously, such other party may include, but is not limited to another user (s), a concierge, a bartender, a cocktail waitress, and/or any other party with whom two-way communication is desired.

While not shown, an alphanumeric keypad may also be provided for facilitating communication. Of course, such alphanumeric keypad may include a mechanical alphanumeric keypad, and/or a virtual alphanumeric keypad displayed via the main display 9716.

Optionally, a separate display 9744 may be positioned on the gaming machine 9700 for dedicated use during such two-way communication. Of course, both the main display 9716 and the separate display 9744 may be used in combination (i.e. for two-way communication with multiple parties, etc.), as appropriate. This may be particularly beneficial when the gaming machine 9700 is not in play.

As an additional option, video conferencing, real-time or near real-time game-related or non-game related gaming machine user interaction, as well as various other features beyond (and/or in addition to) mere security monitoring functions may be carried out utilizing the gaming machine 9700. Of course, non-real-time two-way communication may further be provided.

In order to control the aforementioned two-way communication, a communication control interface 9746 may be utilized. As an option, such communication control interface 9746 may simply be displayed on the main display 9716 (or the separate display 9744, if desired). In use, the communication control interface 9746 may be used for allowing a user to initiate the two-way communication, control with whom the two-way communication is initiated, as well as terminate two-way communication. For example, a plurality of buttons may be depicted on the communication control interface 9746, each corresponding to a concierge, a bartender, another user, a cocktail waitress, etc. for initiating communication therewith.

As an option, the two-way communication may or may not be carried out during play of a game on the gaming machine 9700. For example, the game being played on the gaming machine 9700 may be continued during the two-way communication. In one embodiment, this may be accomplished by ensuring that the separate display 9716 or only a portion of the main display 9716 is utilized for the two-way communication. Of course, only audible two-way communication may be allowed, as an option. To this end, service may be requested during play and/or two-way communication among gaming machine users may be allowed to enhance a multiple-user experience (e.g. allowing users to monitor each other's score, play, etc. and comment thereon in real-time, etc.). Still yet, in the alternative, the game may be paused, or at least a portion (e.g. audible portions, visual portions, etc.) be suppressed to accommodate the two-way communication.

In one optional embodiment, to facilitate two-way communication with other gaming machine users, the gaming machine 9700 may be equipped with a gaming card reader/processor 9750. In such embodiment, a plurality of the gaming machine users are each provided with gaming cards 9752. Such gaming cards 9752 may include a player identifier and an account tracking identifier for tracking a monetary account associated with the player.

It should be noted that, in the context of the present description, any substitute mechanism [i.e. biometric identifier and associated database, jewelry-mounted radio-frequency identifier (RFID), personal identifier number (PIN), etc.] may be used as a substitute for the gaming card 9752 and associated gaming card reader/processor 9750.

As an option, for reasons that will soon become apparent, the gaming card 9750 may include a plurality of additional player identifiers associated with the player identifier. One sample data structure that may be situated on each gaming card 9750 is set forth in Table 2.

TABLE 2

| | | Associated Player |
|---|---|---|
| Player Identifier | Account Information | Identifiers |
| Player ID1 | Player Balance | Player ID2 |
| | Player Credit | Player ID3 |
| | Player Local Residence | Player ID4 |

This data structure may be established upon obtaining the card when the user first enters and/or re-enters a casino. For example, the user may arrive with a group (e.g. family, a party of friends, part of an organization attending a seminar, etc.), and may manually associate the other players of the group with his/her player identifier, as set forth in Table 2. Of course, this may be done automatically based on reservations, predetermined lists, etc. As a further option, a player may have multiple groups associated therewith. In such case, the user may have multiple lists of player identifiers each associated with a different group.

To this end, in the present embodiment, a user may insert the associated gaming card 9752 into the gaming card reader/processor 9750 of the corresponding gaming machine 9700, during play, for allowing the user to communicate with players associated therewith by way of any one or more of the communication devices associated with the gaming machine 9700.

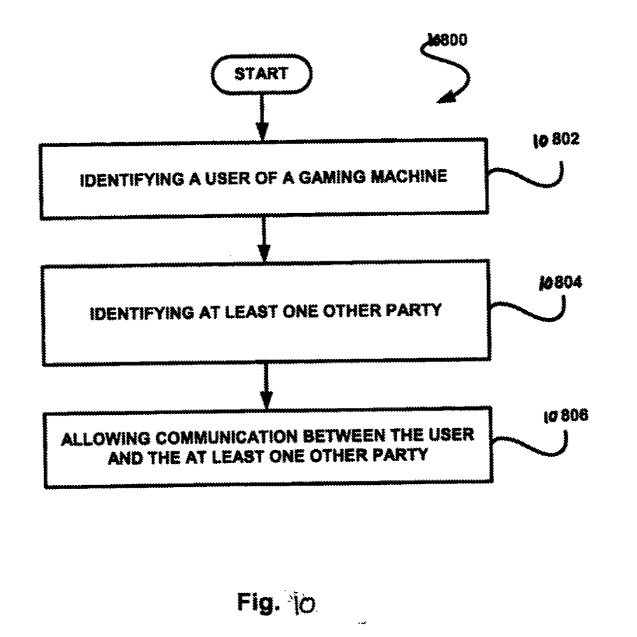

More information associated with one exemplary embodiment of such specific two-way communication will be set forth in FIG. 10.

FIG. 10 shows a method 10800 for allowing communication between a gaming machine user and at least one other party, in accordance with one embodiment. As an option, the method 10800 may be implemented in the context of the architecture and environment of the previous figures. Of course, however, the method 10800 may be carried out in any desired environment.

Initially, in operation 10802, at least one first user of a gaming machine is identified. As an option, this may be accomplished by reading a data structure (e.g. Table 2 hereinabove, etc.) from a gaming card associated with the first user positioned and playing at a first gaming machine. As a further option, such operation 10802 may include identifying a player identifier associated with the first user. Of course, any other available identifying technique may be used to accomplish this operation.

Next, in operation 10804, at least one other party is identified. Such other party may include, but is not limited to another gaming machine user (who may be identified similar to operation 10802), a concierge, a bartender, a cocktail waitress, and/or any other party who desires to communicate with the at least one user.

To this end, communication may be provided between the at least one user and the at least one other party. See operation 10806. Thus, communication is facilitated between a plurality of gaming machine users. Further, paging may be performed in a more personal manner by avoiding use of a public address system by paging a user directly at an associated gaming machine.

Of course, the communication of operation 10806 may be initiated and controlled in any desired manner. For example, prior to operation 10806, it may be determined whether the at least one user is authorized to communicate with the at least one other party. Further, such determination may be provided in any desired manner [i.e. reading a data structure (e.g. Table 2 hereinabove etc.)]. Thus, the communication may be provided based on the foregoing determination.

Further, communication may even be provided between more than two parties simultaneously. For instance, split-screens, etc. may be used to allow multiple users to simultaneously communicate from remote locations in the casino environment.

Still yet, a “presence” of all other users associated therewith may be displayed by the gaming machine during play. To this end, each of the users may select with whom communication is desired, from a set of available users.

Even still, in combination with and/or instead of operation 10806 (in the context of an example where the at least one other party is a second gaming machine user), the first gaming machine may be located for the second gaming machine user. Of course, the present embodiment may have numerous applications.

Just by way of example, a map of all gaming machines (and an associated area of the casino or (gaming environment) may be stored. Upon locating the gaming machine being used by the first user, a map may be presented (to the second user at the second gaming machine, for example), in order to thereby locate the first user. Since the location of the second user is also known, walking directions may also be provided. Thus, users may thus more easily locate each other (as well as communicate with each other), during use of the present embodiment.

More illustrative information will now be set forth regarding various optional architectures and features with which the foregoing technique may or may not be implemented with the present embodiment, per the desires of the user. It should be strongly noted that the following information is set forth for illustrative purposes and should not be construed as limiting in any manner. Any of the following features (and previous, for that matter) may be optionally incorporated with or without the exclusion of other features described during the description of the present embodiment.

Additional Exemplary Options

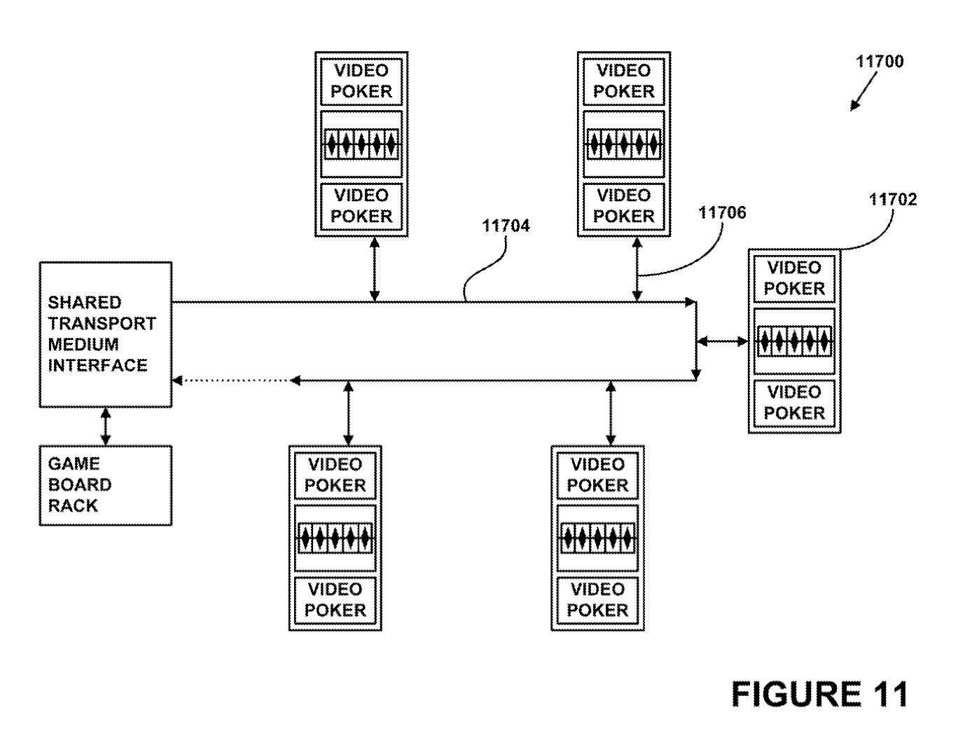

FIG. 11 illustrates a gaming machine network 11700 configured in a tapped configuration. As shown, the gaming machine network 11700 includes a plurality of gaming machines 11702 that are each coupled to a line 11704. Such line 11704 may optionally be configured in a single-ended, or a closed-loop configuration (see dashed lines), either of which communicate data to and from a back-end computer (e.g. BEC 10 from FIGS. 1 and 2, for example, etc.) via any desired interface. Coupling each gaming machine 11702 to the line 11704 is a bidirectional interface 11706.

In one embodiment, such line 11704 may, optionally, take the form of the transport medium 13 of FIG. 1 et al. that supports proprietary physical and protocol information exchanges as well as multiple physical and data protocols (Ethernet, DSL, etc.). Of course, however, the gaming machines 11702 may be interconnected via any desired line 11704 capable of providing a tapped configuration.

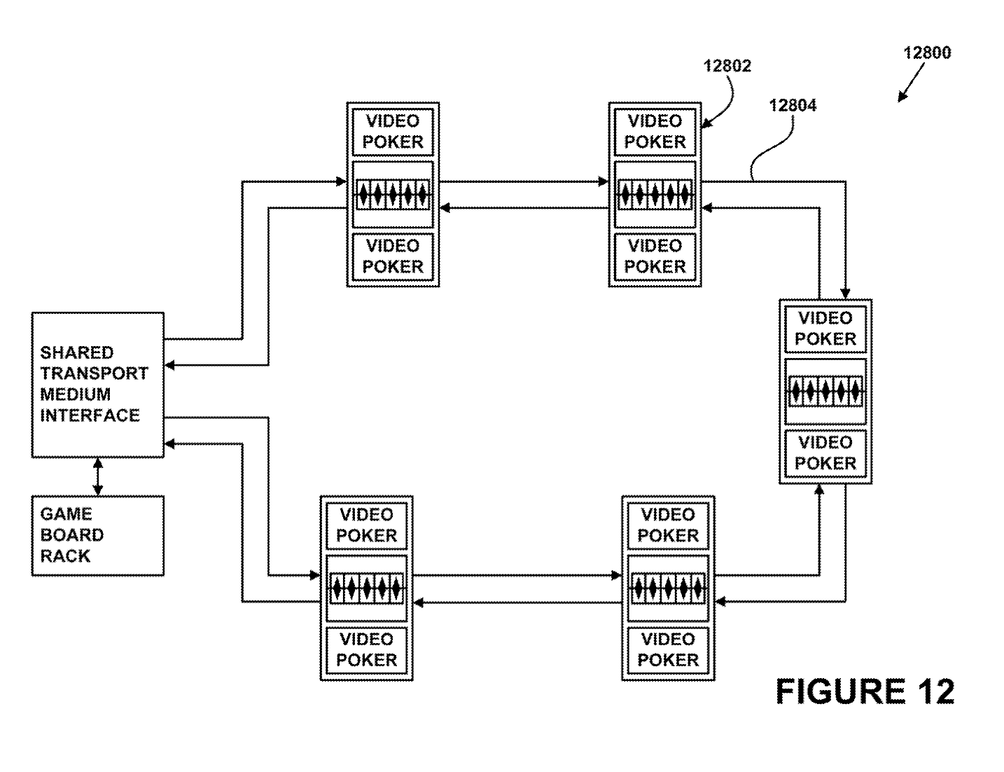

FIG. 12 illustrates a gaming machine network 12800 configured in a daisy-chain configuration. As shown, the gaming machine network 12800 includes a plurality of gaming machines 12802 that are each coupled to at least one line 12804.

In one embodiment, the gaming machines 12802 are serially coupled via a pair of bidirectional lines 12804 which communicate data to and from a back-end computer (e.g. BEC 10 from FIGS. 1 and 2, for example etc.) via any desired interface. As an option, the wires associated with the bidirectional lines 12804 may be contained in the same bundle.

Again, in one embodiment, the bidirectional lines 12804 may, optionally, take the form of the transport medium 13 of FIG. 1 et al. that supports proprietary physical and protocol information exchanges as well as multiple physical and data protocols (Ethernet, DSL, etc.). Of course, however, the gaming machines 12802 may be interconnected via any desired line 12804 capable of providing a daisy-chain configuration.

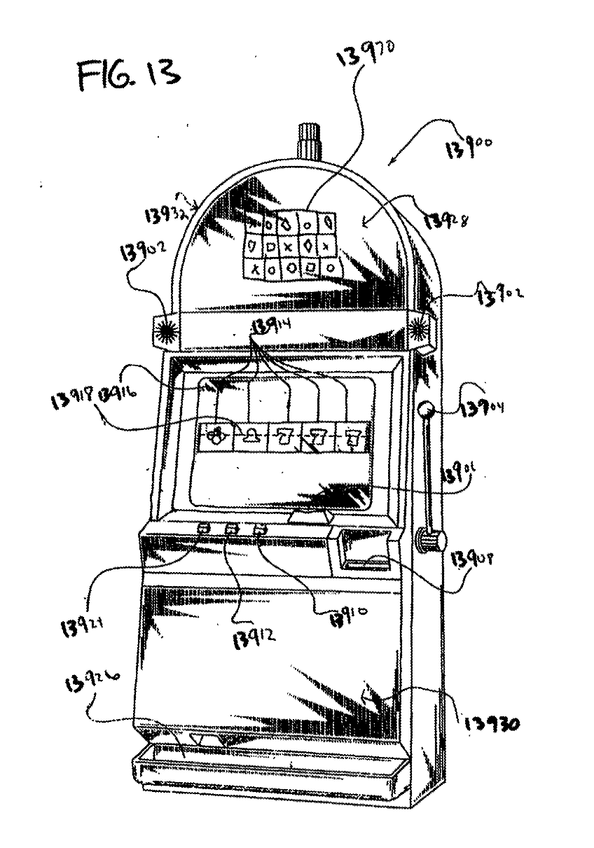

FIG. 13 illustrates a gaming machine 13900, in accordance with one embodiment. It should be noted that the present gaming machine 13900 may or may not be used in the context of the previous figures. Most importantly, it should be understood that the present gaming machine 13900 is set forth for illustrative purposes only, and should not be construed as limiting in any manner.

As shown, the gaming machine 13900 includes a conventional reel-type slot gaming machine 13900. The gaming machine 13900 includes an exterior housing 13932 and a front face including a primary gaming machine main display 13916, and a belly glass 13930.

While the gaming machine 13900 is shown to include a conventional reel-type slot gaming machine 13900, it should be noted that the gaming machine 13900 may take the form of absolutely any game of chance. Thus, the present reel-type slot gaming machine embodiment is set forth for illustrative purposes only and should not be construed as limiting in any manner. To this end, any (or none) of the following features of the reel-type slot gaming machine embodiment may be incorporated into the gaming machine, and still fall within the scope of the claims.

As shown, the primary gaming machine main display 13916 includes windows 13914 each of which displays a single reel assembly of the slot gaming machine 13900. Horizontal pay lines 13918 span the windows and allow for a single winning combination. The main display 13916 includes a cathode ray tube (CRT), liquid crystal display (LCD), organic light emitting diode (OLED) display, etc., with a touch screen layer positioned over the display which may be used to allow user input in lieu of mechanical manual control.

Player buttons 13910, 13912, and 13924 are further provided between the belly glass 13930 and main display 13916 and allow the player to control operation of the gaming machine 13900 in combination with the associated touch screen. In addition, a lever 13904 may be included on one side of the exterior housing 13932 to allow a player alternative control of the gaming machine 13900. A coin acceptor 13906 and a bill acceptor 13908 are provided near the play buttons as shown. Further, a coin tray 13926 is provided near the bottom of slot gaming machine 13900 to collect coin pay outs from winning plays.

Strictly as an option, a secondary gaming machine 13928 may be positioned on a top portion of the gaming machine 13900. Such secondary gaming machine 13928 may include any of the desired features set forth earlier during the description of the main display 13916. Further, other optional features such as speakers 13902 may be included, as desired.

More illustrative information will now be set forth regarding various optional architectures and features with which the foregoing technique may or may not be implemented with the present embodiment, per the desires of the user. It should be strongly noted that the following information is set forth for illustrative purposes and should not be construed as limiting in any manner. Any of the following features (and previous, for that matter) may be optionally incorporated with or without the exclusion of other features described during the description of the present embodiment.

Additional Exemplary Options

FIG. 4 illustrates a gaming machine 14700 that may be utilized for reconciling biometric information, and smart device and/or personal identifier information, in accordance with one embodiment. While not shown, the gaming machine 14700 may optionally be coupled to other similar gaming machines 14700 via a network (not shown).

In one embodiment, such network may, optionally, take the form of the transport medium 13 of FIG. 1 or 7, wherein the gaming machine 14700 includes an electronic gaming machine that interfaces such transport medium 13. Of course, however, the gaming machines 14700 may be interconnected via any desired network capable of allowing network communication.

As shown, the gaming machine 14700 includes a conventional reel-type slot gaming machine 14700. The gaming machine 14700 includes an exterior housing 14732 and a front face including a primary gaming machine main display 14716, and a belly glass 14730.

While the gaming machine 14700 is shown to include a conventional reel-type slot gaming machine 14700, it should be noted that the gaming machine 14700 may take the form of absolutely any game of chance. Thus, the present reel-type slot gaming machine embodiment is set forth for illustrative purposes only and should not be construed as limiting in any manner. For example, a gaming-relate cash machine, a gaming-related registration machine, a table-game, etc. may incorporate any desired features of the present description for reconciling biometric information, and smart device and/or personal identifier information. To this end, any (or none) of the following features of the reel-type slot gaming machine embodiment may be incorporated into the gaming machine, and still fall within the scope of the claims.

As shown, the primary gaming machine main display 14716 includes windows 14714 each of which displays a single reel assembly of the slot gaming machine 14700. Horizontal pay lines 14718 span the windows and allow for a single winning combination. The main display 14716 may, in one embodiment, include a cathode ray tube (CRT), liquid crystal display (LCD), organic light emitting diode (OLED) display, etc., with a touch screen layer positioned over the display, which may be used to allow user input in lieu of and/or in addition to mechanical manual control.

Player buttons 14710, 14712, and 14724 are further provided between the belly glass 14730 and main display 14716 and allow the player to control operation of the gaming machine 14700 in combination with the associated touch screen. In addition, a lever 14704 may be included on one side of the exterior housing 14732 to allow a player alternative control of the gaming machine 14700. A coin acceptor 14706 and a bill acceptor 14708 are provided near the play buttons as shown. Further, a coin tray 14726 is provided near the bottom of slot gaming machine 14700 to collect coin pay outs from winning plays.

Strictly as an option, a secondary gaming machine 14728 may be positioned on a top portion of the gaming machine 14700. Such secondary gaming machine 14728 may include any of the desired features set forth earlier during the description of the main display 14716.

As yet another option, the gaming machine 14700 may be equipped with a microphone 14742 and a camera 14740 positioned at a height on the gaming machine 14700, such that at least a face of a user is directed thereinto, during use of the gaming machine 14700. Still yet, speakers 14702 may be provided. In use, the microphone 14742, camera 14740, speakers 14702, and main display 14717 may be used by a user of the gaming machine 14700 to communicate with at least one other party.

For example, such other party may include, but is not limited to another user(s), a concierge, a bartender, a cocktail waitress, and/or any other party with whom two-way communication is desired. As an additional option, video conferencing, real-time or near real-time game-related or non-game related gaming machine user interaction, as well as various other features may be carried out utilizing the gaming machine 14700.

In order to control the aforementioned two-way communication, a communication control interface 14746 may be utilized. Such communication control interface 14746 may simply be displayed on the main display 14716. In use, the communication control interface 14746 may be used for allowing a user to initiate the two-way communication, control with whom the two-way communication is initiated, as well as terminate two-way communication. For example, a plurality of buttons may be depicted on the communication control interface 14746, each corresponding to a concierge, a bartender, a cocktail waitress, etc. for initiating communication therewith.

In another embodiment, the gaming machine 14700 may be equipped with a smart device reader/processor 14750. In such embodiment, a plurality of the gaming machine users are each provided with a smart device 14752. Such smart device 14752 may include a player identifier and an account tracking identifier for tracking an account associated with the player, where the account is capable of accounting for available funds as well as accumulated awards. As an option, the smart device 14752 may include a plurality of additional player identifiers associated with the player identifier, for facilitating the aforementioned communication between associated gaming machine users.

For reasons that will soon become apparent, in one embodiment, the smart device 14752 may further include smart device information in the form of a biometric identifier associated with the appropriate owner of the smart device 14752. Such biometric identifier may include any information relating to any biological aspect (e.g. fingerprint, retina, iris, DNA, etc.) associated with the gaming machine user.

It should be further noted that, in the context of the present description, any mechanism (i.e. smart card, jewelry-mounted radio-frequency identifier, etc.) may be used as the smart device 14752.

In yet another embodiment, the smart device reader/processor 14750 may be excluded in favor of and/or supplemented with a personal identification number (PIN) input device/processor. To this end, a physical smart device may not be required, and a user need only memorize an identifier capable of being input by any desired input device (e.g. keypad, keyboard, etc.).

Further provided is a biometric identifier module 14760 positioned at an appropriate location on the gaming machine 14700, for receiving biometric information from the user. As an option, the biometric identifier module 14760 may be positioned at eye-level for receiving retina and/or iris information, at waist-level for receiving fingerprint information, etc.

To this end, in the present embodiment, a user may insert the associated smart device 14752 into the smart device reader/processor 14750 of the corresponding gaming machine 14700 for receiving smart device information and the appropriate biometric identifier. Further, the user may engage biometric identifier module 14760 so that the biometric information of the user may be received.

In use, such received biometric information and smart device information (e.g. biometric identifier, etc.) are then reconciled, so that the user may be conditionally allowed to use the gaming machine, based on the reconciliation. Such reconciliation may involve any desired processing that determines whether the biometric information and smart device information identify the same gaming machine user or group of users.

In one embodiment, such processing may be carried out utilizing a processor (not shown) located at the gaming machine 14700, which is, in turn, coupled to the biometric identifier module 14760 and the smart device reader/processor 14750. It should be noted that any of the foregoing components may be located at the gaming machine 14700 and/or at a server [in a network environment (e.g. see environment of FIGS. 1-2, etc.)]. Of course, the aforementioned components and/or information may be distributed in any desired manner.

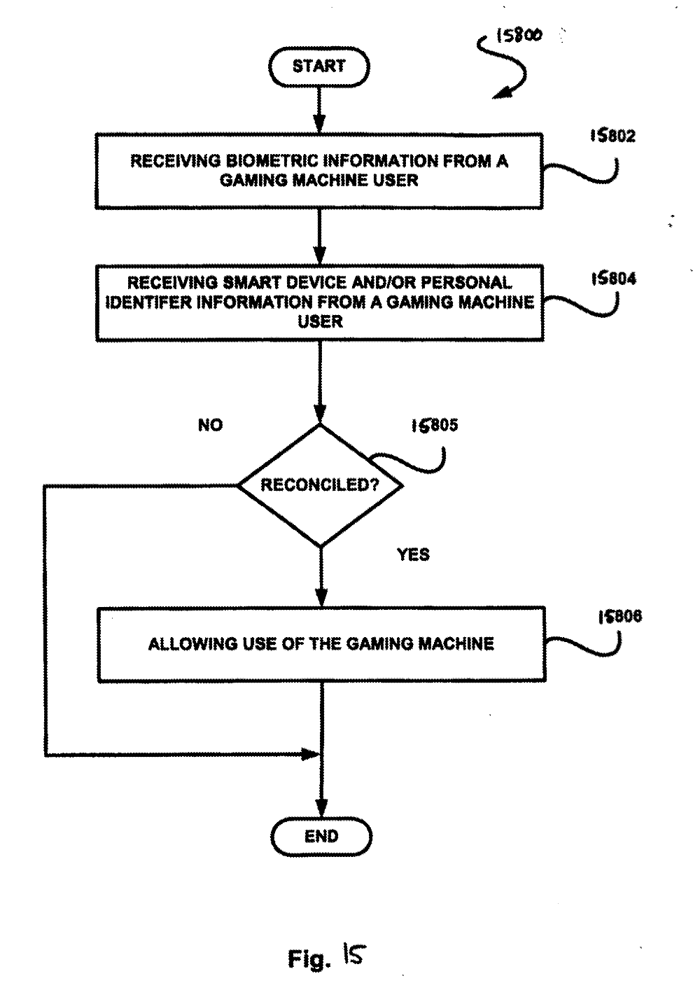

More exemplary details associated with one optional embodiment of the aforementioned reconciliation will now be set forth in FIG. 15.

FIG. 15 shows a method 15800 for reconciling received biometric information and smart device information and/or personal identifier information, in accordance with one embodiment. As an option, the method 15800 may be implemented in the context of the architecture and environment of the previous figures. Of course, however, the method 15800 may be carried out in any desired environment.

Initially, in operations 15802-15804, biometric information, and smart device and/or personal identifier information are received from a gaming machine user.

Again, in the context of the present description, such biometric information may include any information relating to any biological aspect (e.g. fingerprint, retina, iris, DNA, etc.) associated with the gaming machine user. Still yet, the smart device information may include any information that identifies the gaming machine user utilizing a device including, but not limited to a card, RFID device, jewelry, ornament, pin and/or any other device capable of storing the identifying information. As an option, such identifying information may include a biometric identifier. Of course, the personal identifier information (e.g. PIN number, etc.) may be received, which is associated with the biometric identifier.

Next, in decision 15805, such received biometric information, and smart device and/or personal identifier information are then reconciled. This may be accomplished in any desired manner. For example, the biometric identifier of the smart device or associated with the personal identifier information may simply be compared with the biometric information.

While one technique of carrying out decision 15805 is set forth above, it should be noted that any processing may be used that determines whether the biometric information, and smart device and/or personal identifier information identify the same gaming machine user or group of users. For example, the smart device information may simply include a player identifier that is used to look-up a biometric identifier in a local and/or remote database, which is then, in turn, compared to the biometric information received from the user.

Next, in operation 15806, use of the gaming machine (and/or any gaming-related transaction, for that matter) is then conditionally, allowed based on the reconciliation. To this end, a more secure technique is provided for authenticating gaming machine users. Thus, a true cashless gaming environment may be established.

Numerous ancillary applications may be used in combination with the present embodiment. For example, since a location of a user may be verified upon a user entering their smart device information and/or personal identifier information, communication between associated users may be established via a speaker, display, camera, microphone, etc. Further, paging may be performed in a more personal manner by avoiding use of a public address system by paging a user directly at an associated gaming machine.

An example of use in the context of the method 15800 of FIG. 15 will now be set forth. It should be noted that such example is set forth for illustrative purposes only, and should not be construed as limiting in any manner. During registration at a gaming establishment or the like, biometric information may be collected and stored on a smart device in the form of the aforementioned biometric identifier, along with any other information of interest or need (e.g. user name, account information, etc.). This biometric information may also be secured on a server computer. Encryption may optionally be used to further secure the biometric information.

In use, a user may contribute money to their account for use during play of one or more gaming machines. This amount may be stored and tracked utilizing a server computer of an establishment. In order to play a gaming machine and/or initiating a gaming-related transaction, the user may insert or assert the smart device (e.g. at a game verification unit, etc.), and submit their biometric information.

Such information is then compared for reconciliation purposes. A match may enable play, and the user may wager against their account tracked on the server computer. Whether or not the user is verified, some user information may be sent back to the server at the time of verification.

To this end, a user does not have to wait for verification. Further, low-cost verification typically runs 1 error in 100,000 against a database. In the present embodiment, one needs only to verify against one card (i.e. one-to-one). Further, a lost smart device has no value, and credits may be held on a server computer.

More illustrative information will now be set forth regarding various optional architectures and features with which the foregoing technique may or may not be implemented with the present embodiment, per the desires of the user. It should be strongly noted that the following information is set forth for illustrative purposes and should not be construed as limiting in any manner. Any of the following features (and previous, for that matter) may be optionally incorporated with or without the exclusion of other features described during the description of the present embodiment.

Additional Exemplary Options

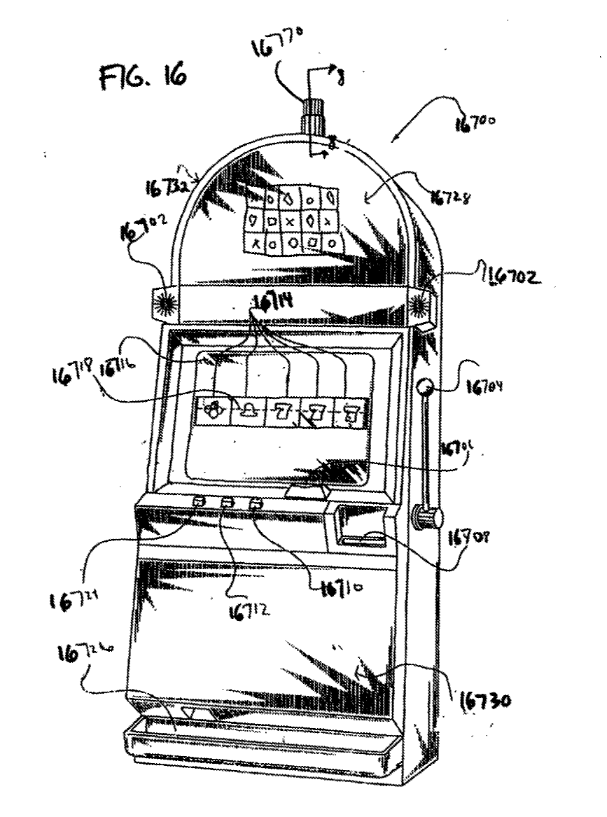

FIG. 16 illustrates a gaming machine 16700, in accordance with one embodiment. It should be noted that the present gaming machine 16700 may or may not be used in the context of the previous figures. Most importantly, it should be understood that the present gaming machine 16700 is set forth illustrative purposes only, and should not be construed as limiting in any manner.

As shown, the gaming machine 16700 includes a conventional reel-type slot gaming machine 16700. The gaming machine 16700 includes an exterior housing 16732 and a front face including a primary gaming machine main display 16716, and a belly glass 16730.

While the gaming machine 16700 is shown to include a conventional reel-type slot gaming machine 16700, it should be noted that the gaming machine 16700 may take the form of absolutely any game of chance. Thus, the present reel-type slot gaming machine embodiment is set forth for illustrative purposes only and should not be construed as limiting in any manner. To this end, any (or none) of the following features of the reel-type slot gaming machine embodiment may be incorporated into the gaming machine, and still fall within the scope of the claims.

As shown, the primary gaming machine main display 16716 includes windows 16714 each of which displays a single reel assembly of the slot gaming machine 16700. Horizontal pay lines 16718 span the windows and allow for a single winning combination. The main display 16716 may, in one embodiment, include a cathode ray tube (CRT), liquid crystal display (LCD), organic light emitting diode (OLED) display, etc., with a touch screen layer positioned over the display which may be used to allow user input in lieu of manual control.

Player buttons 16710, 16712 and 16724 are further provided between the belly glass 16730 and main display 16716 and allow the player to control operation of the gaming machine 16700 in combination with the associated touch screen. In addition, a lever 16704 may be included on one side of the exterior housing 16732 to allow a player alternative control of the gaming machine 16700. A coin acceptor 16706 and a bill acceptor 16708 are provided near the play buttons as shown. Further, a coin tray 16726 is provided near the bottom of slot gaming machine 16700 to collect coin pay outs from winning plays.

Strictly as an option, a secondary gaming machine 16728 may be positioned on a top portion of the gaming machine 16700. Such secondary gaming machine 16728 may include any of the desired features set forth earlier during the description of the main display 16716. Further, other optional features such as speakers 16702 may be included, as desired.

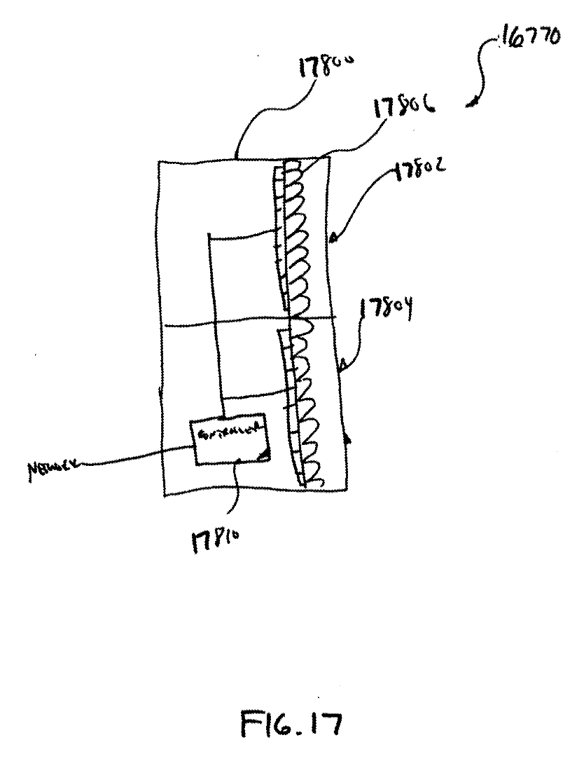

With continuing reference to FIG. 16, a gaming machine candle 16770 is shown to be vertically mounted to an apex of the secondary gaming machine 16728 of the gaming machine 16700. As mentioned previously, however, the candle may include anything mounted on or in the vicinity of a top portion of the gaming machine, where the candle is capable of displaying different indicators (e.g. lights, colors, combinations thereof, etc.) to indicate a mode of use in which the associated gaming machine is current operating. More information will be set forth hereinafter regarding one exemplary gaming machine candle 16770 during reference to FIG. 17.

While not shown, the gaming machine 16700 may optionally be coupled to other similar gaming machines 16700 via a network (not shown), for reasons that will soon become apparent. In one embodiment, such network may, optionally, take the form of the transport medium 13 of FIG. 1 or 2, wherein the gaming machine 16700 includes an electronic gaming machine that interfaces such transport medium 13. Of course, however, the gaming machines 16700 may be interconnected via any desired network capable of allowing network communication.

In use, a status of a gaming machine may be identified. Such status may relate to an aspect of gaming such as a jurisdictional requirement, a cashless gaming mode, and/or an enhanced entertainment experience mode. Further, the status may be identified utilizing a local controller, etc. that may be adjusted manually and/or automatically in a local matter. In yet another embodiment, the status may be identified utilizing a server computer, etc. that may be used to adjust the status of the machine via the aforementioned network.

To this end, such status of the gaming machine is indicated by the gaming machine candle. Further, in the network-enabled environment embodiment, the candles of a plurality of gaming machines may be controlled via the network by a remote administrator. Still yet, a status of the gaming machine candle may be monitored from afar. Just by way of example, a gaming machine candle failure may be communicated from the gaming machine to the server computer and/or a remote administrator, in order to initiate a prompt repair.

Even still, in the network-enabled environment embodiment, sequential gaming machine candle firing (i.e. similar to a “wave” at football games, etc.) may be initiated by a server computer. Also, multi-player and/or multi-player-bonus play may be indicated by candle color, candle light chasing, and/or light popping.

FIG. 17 is a cross-section of line 8-8 shown in FIG. 16, showing an exemplary gaming machine candle 16770, in accordance with one embodiment. As an option, the gaming machine candle 16770 may be constructed with a housing 17800 having a top portion 17802 and a lower portion 17804. Of course, while two portions are shown in FIG. 17, it should be noted that any number of portions (l-n) may be included. Just by way of example, additional portions of the gaming machine candle 16770 may be used to indicate machine conditions.

Further included is at least one light 17806 mounted in each portion of the gaming machine candle 16770. While an incandescent light may be utilized in various embodiments, it should be noted that a plurality of light emitting diodes (LEDs) may be used to improve operability and life expectancy. In one embodiment, the LEDs may include multi-colored LEDs each capable of illuminating with a plurality of colors.

For example, tri-color LEDs may be driven to display four denomination colors, and may also display other colors that may be required. For instance, a color may be designated to indicate a machine is multi-denominational before play. Further, the LEDs may be programmed to “pop” (i.e. as opposed to blinking, etc.), as well as other lighting features (i.e. color fade, color change, etc.) to further enhance a machine attract mode, a bonus mode, etc.

With continuing reference to FIG. 17, the at least one light 17806 may, in turn, be coupled to a controller/driver 17810 which may reside in the housing 17800 and/or elsewhere in the gaming machine 16700. Further, in a network-enabled environment embodiment, the controller/driver 17810 may be located at a central server and/or may be coupled thereto via a network, as shown.

In use, the controller/driver 17810 may be adapted to receiving control signals for controlling the at least one light 17806 of each portion to indicate a current play denomination, a machine condition code, an attract mode, etc. Still yet, the controller/driver 17810 may provide status information (i.e. failure information, etc.), in order to provide a local and/or remote indication of the same.

Thus, cashless gaming environments (as well as traditional environments) are more effectively served with gaming machine candles that may be changed “on the fly”. It should be noted that, in a cashless gaming environment, change service would not necessarily be required, thus eliminating the need for a top change (white) portion of the candle. Of course, however, such top portion of the candle may still be used as a general purpose service call light, etc.

More illustrative information will now be set forth regarding various optional architectures and features with which the foregoing technique may or may not be implemented with the present embodiment, per the desires of the user. It should be strongly noted that the following information is set forth for illustrative purposes and should not be construed as limiting in any manner. Any of the following features (and previous, for that matter) may be optionally incorporated with or without the exclusion of other features described during the description of the present embodiment.

Additional Exemplary Options

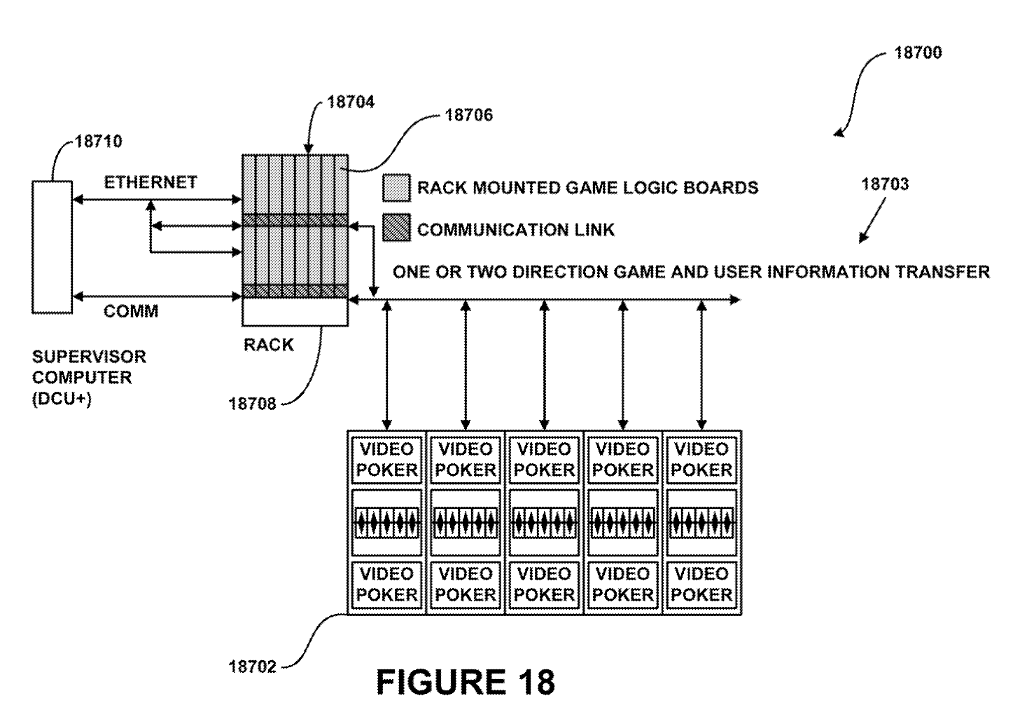

FIG. 18 illustrates a centralized game board architecture 18700, in accordance with one embodiment. Such centralized game board architecture 18700 may, in one embodiment, be implemented in the context of the network architecture of the previous features. Of course, however, the centralized game board architecture 18700 may be implemented in any desired context.

As shown, a plurality of gaming clients 18702 (e.g. see EGMs in FIGS. 1-2, etc., for example) are provided. In the context of the present description, each gaming client 18702 includes at least a display and at least one input device. While, in one embodiment, each gaming client 18702 includes only a display and at least one input device (along with the necessary interface(s)), it should be noted that additional componentry may be included (even some processing and/or storage capabilities, etc.), as desired. As an option, the gaming clients 18702 may be positioned on a casino floor, hotel room, arcade room, etc.

Further included is a centralized repository 18704 of computer processing units 18706. Each of the computer processing units 18706 is connected to at least one of the game clients 18702 for executing a gaming application for play by a user utilizing the gaming client 18702, via a network 18703 (e.g. see transport medium 13 in FIGS. 1-2, etc., for example). In one embodiment, each of the computer processing units 18706 is dedicated to one of the game clients 18702, in a one-to-one exclusive relationship. As a further option, the network may include a daisy chain, a tapped configuration, star-type, and/or any other configuration and/or protocol (e.g. Ethernet, Internet, etc.) that is desired.

In one embodiment, the centralized repository 18704 is located in a centralized location separate from the gaming clients 18702. Further, centralized repository 18704 may include a rack 18708 for stacking computer boards associated with the computer processing units 18706 in an organized manner. Such rack 18708 may further include interfaces for interfacing the computer processing units 18706 with other components in communication therewith. Still yet, the rack 18708 may be situated in an impenetrable housing with a security door or the like, to prevent access to the computer processing units 18706 and associated componentry.

At yet another option, the computer processing units 18706 may be further in communication with a server computer 18710 via the network 18703 and/or any other desired network, for that matter. In one embodiment, in the context of the architecture of FIGS. 1-2, etc., the server computer 18710 may take the form of the DCU 11 and/or back-end server 10. Of course, however, any desired server computer 18710 may be utilized, which communicates with the computer processing units 18706, is desired.

By positioning the computer processing units 18706 associated with the gaming clients 18702 in the centralized repository 18704, access thereto (and the information stored therein) is limited. Enhanced security is thereby provided.

More illustrative information will now be set forth regarding various optional architectures and features with which the aforementioned computer processing unit 18706 and associated board, architecture, etc. may or may not be implemented, per the desires of the user. It should be strongly noted that the following information is set forth for illustrative purposes and should not be construed as limiting in any manner. Any of the following features may be optionally incorporated with or without the exclusion of other features described.

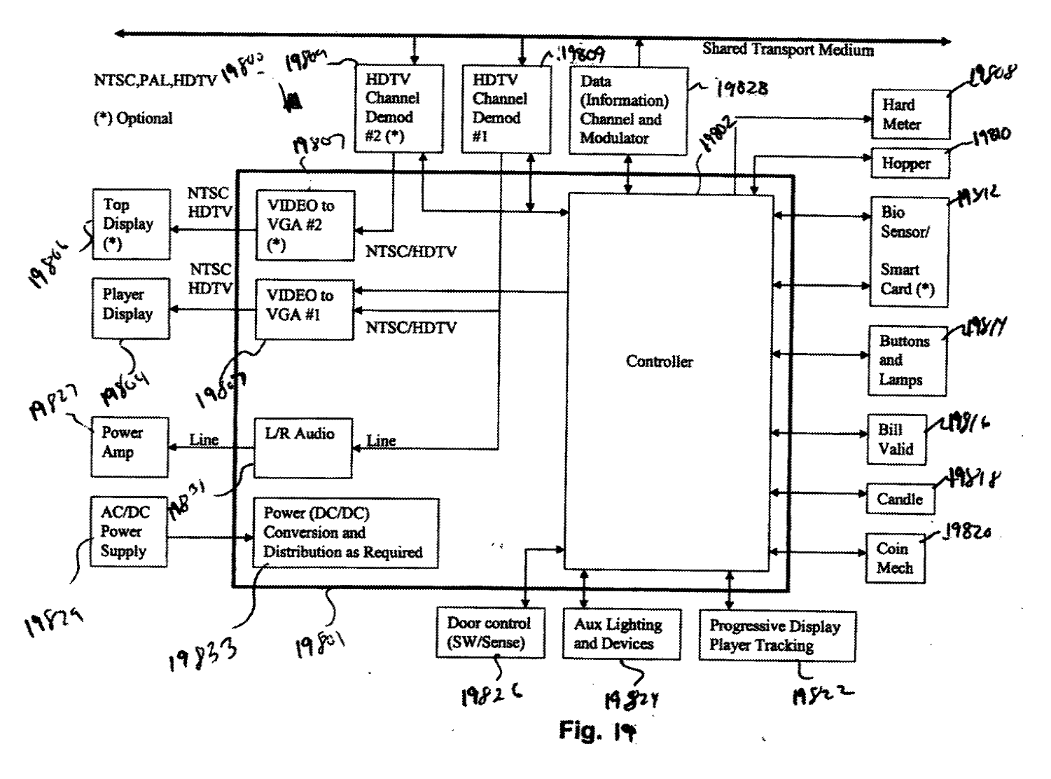

FIG. 19 illustrates one exemplary central processing unit 19800 and associated game board, in accordance with another embodiment. Such exemplary central processing unit 19800 may, in one embodiment, be implemented in the context of the previous computer processing units 18706 of FIG. 18. Of course, however, the exemplary central processing unit 19800 may be implemented in any desired context.

As shown, the central processing unit 19800 is mounted on a game board 19801 and includes a controller 19802. The controller 19802 is further connected to a display 19804 (and optionally a secondary display 19806) mounted in a corresponding gaming client (e.g. see gaming client 18702 in FIG. 18, etc., for example). This connection may be facilitated via at least one video-to-VGA module 19807 that is also mounted on the game board 19801. In use, at least one HDTV channel demodulator 19809 interfaces the video-to-VGA module(s) 19807, controller 19802, and a network (e.g. see transport medium 13 in FIGS. 1-2, etc., for example).

With continuing reference to FIG. 19, a power amplifier 19827 and AC/DC POWER supply 19829 are further mounted in the associated gaming client. Such power amplifier 19827 and AC/DC power supply 19829 interface a left/right audio module 19831 and power conversion/distribution module 19833, as shown. The left/right audio module 19831, in turn, interfaces at least one of the HDTV channel demodulators 19809 for feeding audio to the corresponding gaming client.

Further, the controller 19802 may also be coupled to various additional input/output devices mounted in the corresponding client including, but not limited to a hard meter 19808, a hopper 19810, a biometric sensor and/or smart card reader 19812 (for player authentication), buttons and lamps 19814, bill validator 19816, candle 19818, coin mechanism 19820, progressive display player tracking mechanism 19822, auxiliary lighting device 19824, and door controller 19826. The controller 19802 may further interface such input/output devices to a server computer via a channeled information modulator 19828.

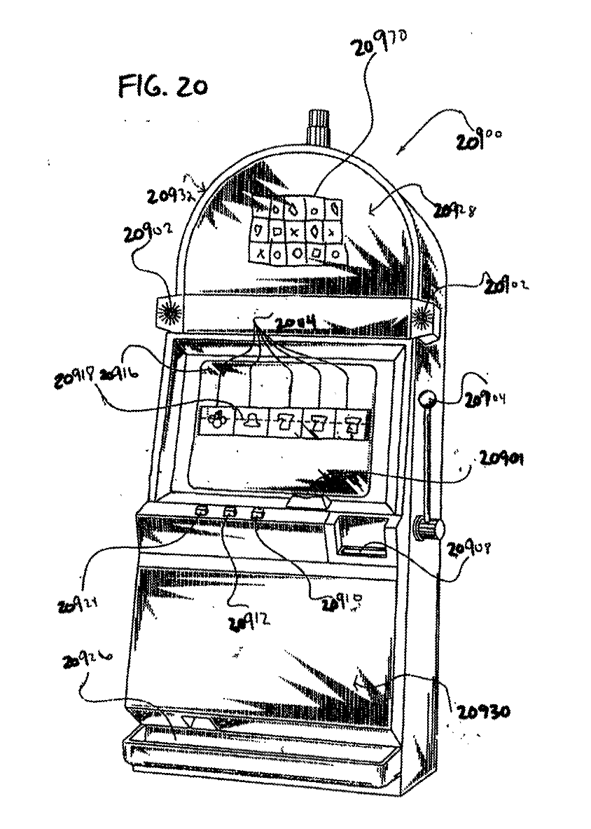

FIG. 20 illustrates a gaming machine 20900, in accordance with one embodiment. It should be noted that the present gaming machine 20900 may or may not be used in the context of the previous figures (e.g. see gaming client 18702 in FIG. 18. etc., for example). Most importantly, it should be understood that the present gaming machine 20900 is set forth or illustrative purposes only, and should not be construed as limiting in any manner.

As shown, the gaming machine 20900 includes a conventional reel-type slot gaming machine 20900. The gaming machine 20900 includes an exterior housing 20932 and a front face including a primary gaming machine main display 20916, and a belly glass 20930.

While the gaming machine 20900 is shown to include a conventional reel-type slot gaming machine 20900, it should be noted that the gaming machine 20900 may take the form of absolutely any game of chance. Thus, the present reel-type slot gaming machine embodiment is set forth for illustrative purposes only and should not be construed as limiting in any manner. To this end, any (or none) of the following features of the reel-type slot gaming machine embodiment may be incorporated into the gaming machine, and still fall within the scope of the claims.

As shown, the primary gaming machine main display 20916 includes windows 20914 each of which displays a single reel assembly of the slot gaming machine 20900. Horizontal pay lines 20918 span the windows and allow for a single winning combination. The main display 20916 may, in one embodiment, include a cathode ray tube (CRT), liquid crystal display (LCD), organic light emitting diode (OLED) display, etc., with a touch screen layer positioned over the display which may be used to allow user input in lieu of manual control.

Player buttons 20910, 20912, and 20924 are further provided between the belly glass 20930 and main display 20916 and allow the player to control operation of the gaming machine 20900 in combination with the associated touch screen. In addition, a lever 20904 may be included on one side of the exterior housing 20932 to allow a player alternative control of the gaming machine 20900. A coin acceptor 20906 and a bill acceptor 20908 are provided near the play buttons as shown. Further, a coin tray 20926 is provided near the bottom of slot gaming machine 20900 to collect coin pay outs from winning plays.

Strictly as an option, a secondary gaming machine 20928 may be positioned on a top portion of the gaming machine 20900. Such secondary gaming machine 20928 may include any of the desired features set forth earlier during the description of the main display 20916. Further, other optical features such as speakers 20902 may be included, as desired, along with the various input/output devices discussed hereinabove in the context of FIG. 19.

Thus, whereas prior art gaming device operation has gaming logic contained within a gaming client and any networking takes place over RS-xxx or Ethernet connections, the present system, in accordance with one embodiment, may have the game logic located remote from the associated gaming client, with game and user information (e.g. audio, video, data, etc.) exchanges taking place over a network.

Enhanced security is thus provided along with convenient game changes, an inexpensive server for competitive and/or cooperative gaming, high scalability, easy service and support, wide and inexpensive bandwidth, etc. Further, built-in repeaters may be provided for long medium lengths, and redundant data traffic on opposing data flows.

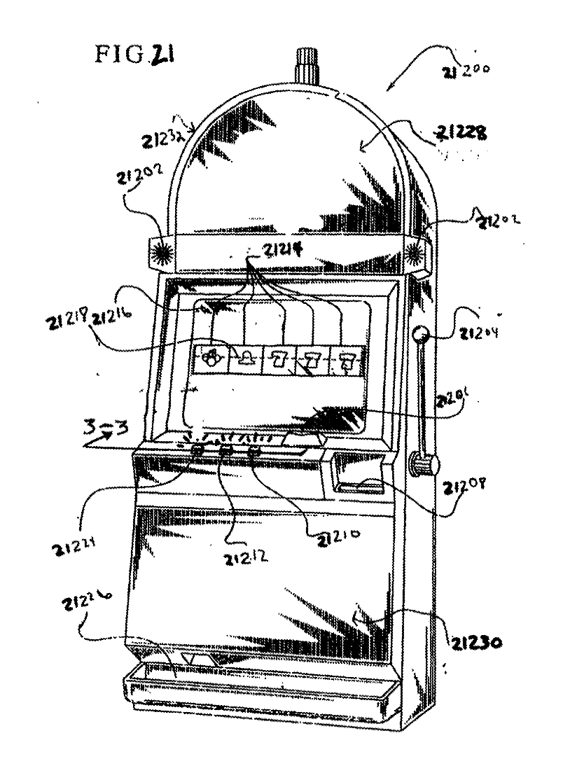

FIG. 21 illustrates a gaming machine 21200, in accordance with one embodiment. As shown, the gaming machine 21200 includes a conventional reel-type slot gaming machine 21200. It includes an exterior housing 21232 and a front face including a gaming machine main display 21216, and a belly glass 21230.

The gaming machine 21200 includes a conventional reel-type slot gaming machine 21200. It should be noted, however, that the gaming machine 21200 may take the form of absolutely any game of chance. Thus, gaming machine, in the context of the present description, may refer to slot machines, automatic roulettes, blackjack, and/or any type of game of chance.

Thus, the present reel-type slot gaming machine embodiment is set forth for illustrative purposes only and should not be construed as limiting in any manner. To this end, any (or none) of the features of the present reel-type slot gaming machine embodiment may be incorporated into the gaming machine, and still fall within the scope of the claims.

As shown, the gaming machine main display 21216 includes windows 21214 each of which displays a single reel assembly of the slot gaming machine 21200. Horizontal pay lines 21218 span the windows and allow for a single winning combination. The main display 21216 includes a cathode ray tube (CRT), liquid crystal display (LCD), etc., with an optional touch screen layer positioned over the display which may be used to allow user input in lieu of and/or in combination with mechanical control.

For mechanical control, player buttons 21210, 21212, and 21224 are provided between the belly glass 21230 and main display 21216 and allow the player to control operation of the gaming machine 21200. In addition, a lever 21204 may be included on one side of the exterior housing 21232 to allow a player alternative control of the gaming machine 21200. A coin acceptor 21206 and a bill acceptor 21208 are further provided near the play buttons, as shown. Finally, a coin tray 21226 is provided near the bottom of slot gaming machine 21200 to collect coin pay outs from winning plays. Other options may include speakers 21202, etc. to enhance play.

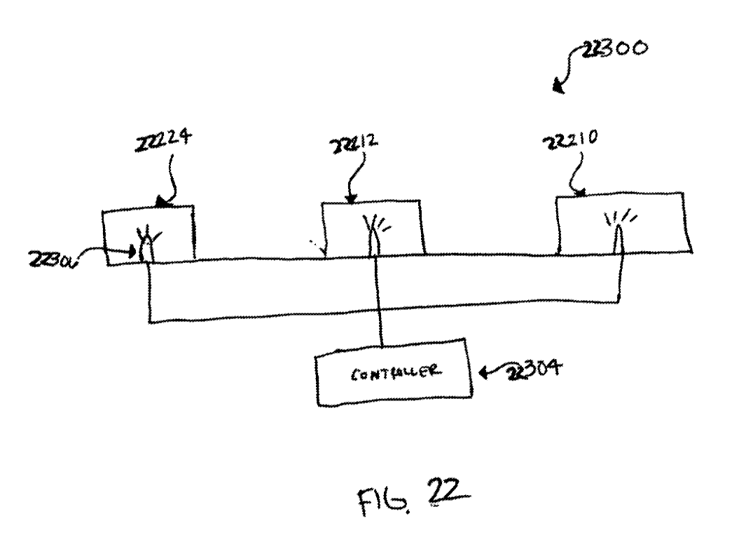

FIG. 22 is a cross-sectional view taken along line 3-3 of FIG. 21, showing the player buttons 21210, 21212, and 21224 and associated lights 22306, in accordance with one embodiment. Again, the present buttons 21210, 21212, and 21224 and associated lights 22306 may be implemented in the context of the gaming machine 21200 of FIG. 21 or, in other embodiments, implemented in any desired context.

As shown, the player buttons 21210, 21212, and 21224 each include a light 22306 capable of emitting light. In one embodiment, the light may include a light emitting diode (LED), LED-alternatives such an electroluminescent light, incandescent light, etc. and/or any other type of light capable of emitting light. It should further be noted that the lights 22306 may take the form of single-colored, multiple-colored, and/or colorless lights 22306. Still yet, the player buttons 21210, 21212, and 21224 may each include multiple lights. Thus, the use of a single light associated with each player button, in the manner shown in FIG. 22, should not be construed as limiting in any way.

With continuing reference to FIG. 22, the player buttons 21210, 21212, and 21224 (and the associated lights 22306) are shown to be coupled to a controller 22304 (i.e. a computer, microprocessor, integrated circuit, circuit board, button board, analog, or digital circuitry, and/or any desired type of logic or the like) for controlling the lights 22306 such that at least one aspect of the lights 22306 is modulated.

In the context of the present description, the at least one aspect of the lights 22306 that is modulated may include intensity, color, and/or any other aspect capable of being modulated. Further, such modulation, in the present description, may refer to any modulating, changing, altering, varying, adjusting, etc. of the at least one aspect.

Optionally, the light intensity may be controlled by way of pulse-width modulation techniques, which are capable of controlling the brightness of LED's. Further, in another embodiment, analog to digital (A/D) converter technology may be utilized in the present context. Of course any technique may be used that is capable of controlling the intensity, brightness, color, or any other aspect of the light.

To this end, more attractive and functionally superior player buttons 21210, 21212, and 21224 (and associated lights 22306) are provided. More information on optional features associated with the aforementioned lights 22306 will now be set forth. Such additional details are set forth for illustrative purposes only, an should not be construed as limiting in any manner.

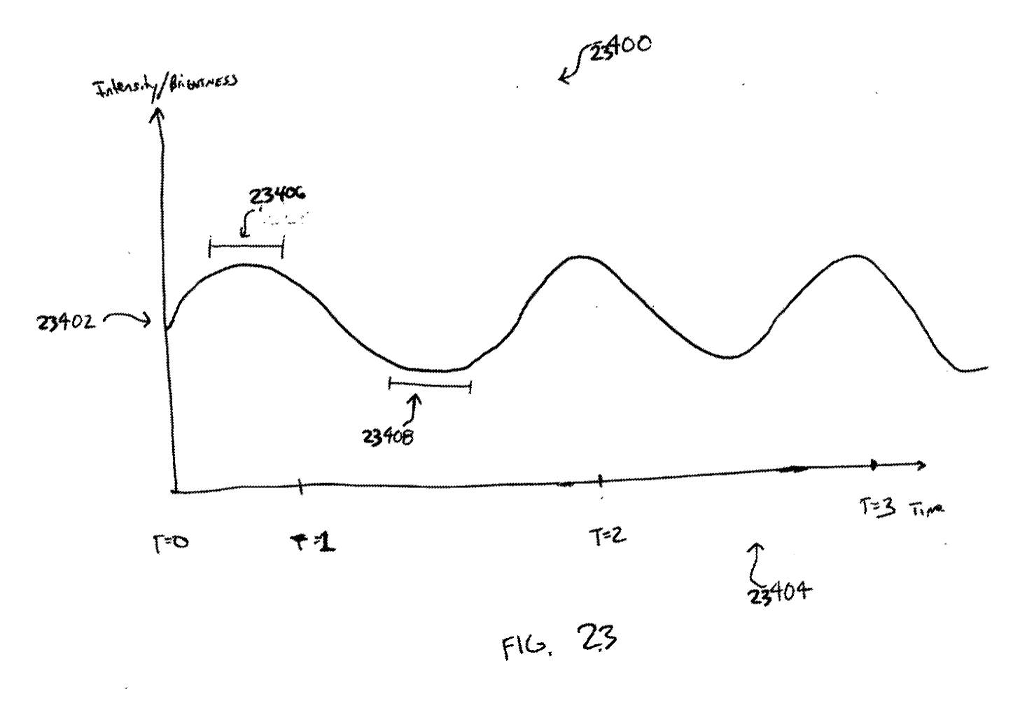

FIG. 23 is a graph showing the continuous variation in light intensity over time with respect to a light (e.g. light 22306 of FIG. 22, etc.) of each player button (e.g. player button 22210, 22212, 22224 of FIG. 22, etc.), in accordance with another embodiment. The light associated with each player button is capable of varying in intensity 23402 as time 23404 progresses. As shown, the light intensity may change at a constant rate, such that the change in intensity is gradual. Of course, the light intensity may change at any rate, or may not even change at all.

Further, the intensity 23402 of the light is capable of changing by increasing to a maximum intensity 23406 and then decreasing to a minimum intensity 23408 in a continuous, cyclical (i.e. sinusoidal, etc.) manner. Still yet, the intensity of the light associated with each player button may change individually or collectively with the other player buttons.

For example, the intensity variations may be random and uncoordinated for each player button. In the alternative, such intensity variations may be synchronized so that the intensity of each player bottom top and bottom out at the same time. The intensity variations may even be a predetermined amount out-of-phase, in order to provide a “rippling” effect among the player buttons. Just by way of example, the intensities may be 60 degrees out-of-phase among three player buttons, in order to maximize this effect.

These options allow for a continuous pattern of change in light intensity that is attractive to prospective players of the gaming machine. More information on optional techniques of color modulation will now be set forth. Such additional details may or may not be used in conjunction with the foregoing intensity modulation. Further, it should be noted the foregoing intensity-related features may be applied in the context of color. In a similar manner, the following color-related features may used to modulate intensity in the manner described.

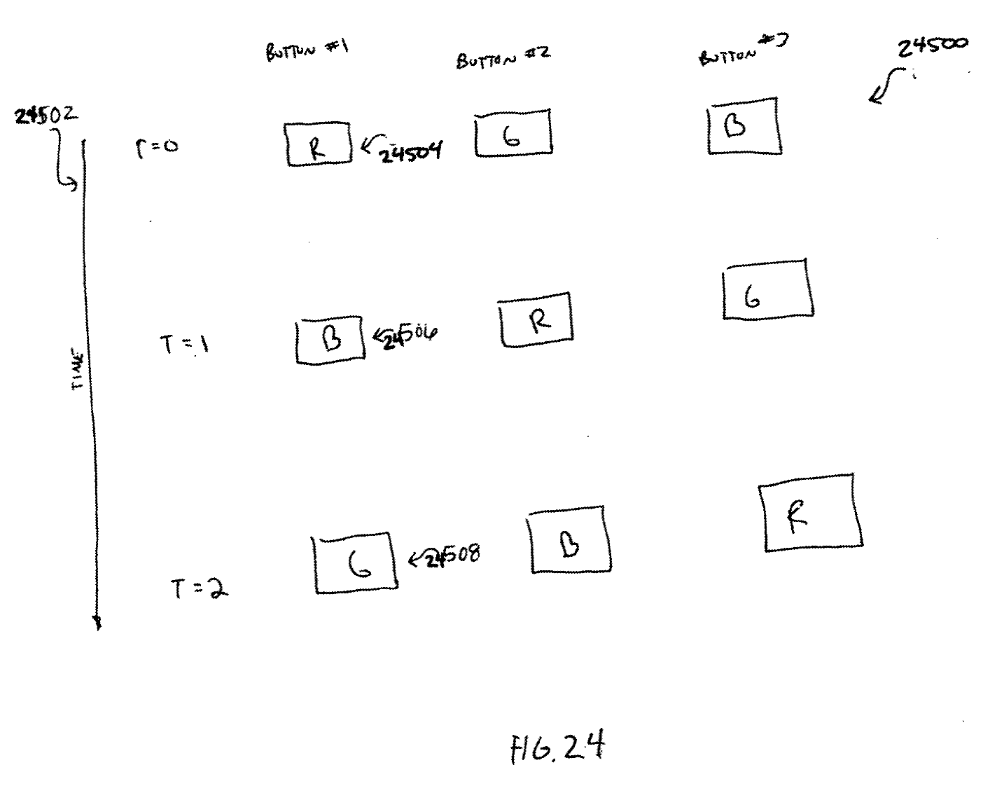

FIG. 24 is a graph showing the continuous variation of light color over time with respect to a light (e.g. light 22306 of FIG. 22, etc.) of each player button (e.g. player button 22210, 22212, 22224 of FIG. 22, etc.), in accordance with yet another embodiment. As shown, in the light associated with each player button is capable of changing color as time progresses.

In particular, in one embodiment, the light associated with each player button may change from red 24504 to blue 24506 to green 24508 as time progresses, in a continuous manner. As shown in FIG. 24, each of three player buttons may show a different color (i.e. red, green, blue) at each instant in time. Further, the change from each color to the next may either be abrupt (i.e. instantly), or gradual (i.e. in a sinusoidal, etc.).

Of course, it should be understood that any pattern of color change, or even no color change may be used with respect to each of the player buttons.

As an option, the color and intensity variations may be either independently or dependently modulated. For example, any color changes (i.e. from one color to the next, etc.) may occur when the intensity of the associated button is at a lowest level.

As yet another option, the foregoing color and/or intensity modulation may operate in a first mode when the corresponding gaming machine is not in use. In such first mode, any of the foregoing modulations may occur in an automatic manner to attract play.

The color and/or intensity modulation may also operate in a second mode, during play of the gaming machine by a user. In the second mode, the color and/or intensity modulation may vary as a function of player input and any win accomplished on the gaming machine, in order to maintain play. For example, upon depression of one of the player buttons, such button may peak in intensity and/or change color, and/or may even deviate from coordination with respect to the remaining player buttons. Further, there may be a special third mode, whereby the lights modulate in a specific manner to indicate a win.

Again, it should be strongly noted that the various features of all of the embodiments set forth herein may or may not be combined, per the desires of the user.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A gaming machine system, comprising:
a plurality of networked gaming machines each with a display and a speaker for providing output, and a camera and a microphone for receiving input;
wherein the displays, speakers, cameras, and microphone are capable of being used by users of the gaming machines to communicate with at least one other party.

2. The gaming machine system of claim 1, wherein the gaming machines include reel-type slot gaming members.

3. The gaming machine system of claim 1, wherein the gaming machines are networked utilizing a wireless transport medium.

4. The gaming machine system of claim 1, wherein the gaming machines are networked utilizing a fiber optic cable transport medium.

5. The gaming machine system of claim 1, wherein the cameras are positioned at a height on the gaming machines for allowing a face of each of the users to be directed into the cameras.

6. The gaming machine system of claim 1, wherein the at least one other party includes another user of another gaming machine.

7. The gaming machine system of claim 1, wherein the at least one other party includes a bartender.

8. The gaming machine system of claim 1, wherein the communication with the at least one other party is provided based on a determination of whether one of the users is authorized to communicate with the at least one other party.

9. The gaming machine system of claim 1, further comprising a virtual alphanumeric keypad displayed via a main display of each of the gaming machines capable of being used by the users of the gaming machines to communicate with the at least one other party.

10. A method, comprising:
communicating utilizing a plurality of networked gaming machines each with a display and a speaker for providing output, and a camera and a microphone for receiving input, over a network;
wherein the displays, speakers, cameras, and microphone are capable of being used by users of the gaming machines to communicate with at least one other party.

11. A gaming machine system, comprising:
a plurality of networked gaming machines each with at least one of a display and a speaker for providing output, and at least one of a camera and a microphone for receiving input;
wherein the at least one of a display and a speaker, and the at least one of a camera and a microphone are capable of being used by users of the gaming machines for two-way communication with at least one other party.

12. The gaming machine system of claim 11, wherein the gaming machines include reel-type slot gaming machines.

13. The gaming machine system of claim 11, wherein the gaming machines are networked utilizing a wireless transport medium.

14. The gaming machine system of claim 11, wherein the gaming machines are networked utilizing a fiber optic cable transport medium.

15. The gaming machine system of claim 11, wherein the cameras are positioned at a height on the gaming machines for allowing a face of each of the users to be directed into the cameras.

16. The gaming machine system of claim 11, wherein the at least one other party includes another user of another gaming machine.

17. The gaming machine system of claim 11, wherein the at least one other party includes a bartender.

18. The gaming machine system of claim 11, wherein the two-way communication is provided based on a determination of whether one of the users is authorized to communicate with the at least one other party.

19. The gaming machine system of claim 11, wherein the two-way communication is facilitated utilizing a plurality of player identifiers included on a gaming card.

20. A method, comprising:
communicating utilizing a plurality of networked gaming machines each with at least one of a display and a speaker for providing output, and at least one of a camera and a microphone for receiving input, over a network;
wherein the at least one of a display and a speaker, and the at least one of a camera and a microphone are capable of being used by users of the gaming machines for two-way communication with at least one other party.
